(19) United States
(12) Patent Application Publication
(10) Pub. No.: US 2023/0334191 A1
(43) Pub. Date: Oct. 19, 2023

(54) SAFETY EVALUATION METHOD AND SYSTEM FOR STRAIGHT-SECTION EXTERNAL GUIDE CYLINDER, AND CORRECTION METHOD AND SYSTEM FOR HEAT EXCHANGER

(71) Applicant: China Special Equipment Inspection and Research Institute, Beijing (CN)

(72) Inventor: Guodong ZHU, Beijing (CN)

(21) Appl. No.: 18/134,746

(22) Filed: Apr. 14, 2023

(30) Foreign Application Priority Data
Apr. 15, 2022 (CN) 202210398776.8

(51) Int. Cl. G06F 30/17

(52) U.S. Cl. CPC G06F 30/17; G06F 2111/10

(57) ABSTRACT

The present disclosure discloses a safety evaluation method and system for a straight-section external guide cylinder, and a correction method and system for a heat exchanger. The safety evaluation method includes: determining a radial displacement formula and a rotation angle formula of the guide cylinder based on symmetrical structural characteristics and real load conditions of the straight-section external guide cylinder, then constructing seven-order matrix equations and solving the equation, then obtaining a stress of each element in the guide cylinder, performing strength evaluation on a bending stress and a membrane stress of each element, and determining a final wall thickness of each element; calculating axial stiffness of the guide cylinder, and performing calculation and correction on a heat exchanger system; obtaining an axial force of the guide cylinder, and further performing calculation and safety evaluation on the straight-section external guide cylinder under the axial force and an internal pressure load.

### CROSS REFERENCE TO RELATED APPLICATION

This patent application claims the benefit and priority of Chinese Patent Application No. 202210398776.8, filed with the China National Intellectual Property Administration on Apr. 15, 2022, the disclosure of which is incorporated by reference herein in its entirety as part of the present application.

### TECHNICAL FIELD

The present disclosure relates to the field of heat exchanger design, and in particular, to a safety evaluation method and system for a straight-section external guide cylinder, and a correction method and system for a heat exchanger.

### BACKGROUND

With the large scale and high parameterization of heat exchanger devices, a straight-section external guide cylinder has become a preferred flow guide structure at an outlet and an inlet of a large-size heat exchanger because of its advantages of being easy to manufacture and compact in structure, further reducing a heat flow dead zone after being provided with an internal distributor, improving stress, and saving an axial space of the shell side of heat exchanger. The actual shape of the straight-section external guide cylinder (that is, a straight-section external guide cylinder with the internal distributor) at a real heat exchanger is shown in FIG. 1.

The straight-section external guide cylinder includes four elements, as shown in FIG. 2, namely, two end plates, an outer cylinder body, an inner cylinder body, and an internal distributor cylinder body (denoted by distribution cylinder bodies 1 and 2 in the FIG. 2); and the internal distributor cylinder body is divided into an opening section and a non-opening section. The elements in the straight-section external guide cylinder are connected to each other in a welded manner. The end plate forms a right angle with each of the inner cylinder body and the outer cylinder body, which forms a discontinuous part of the structure and result in high local stress located at weld area. Thus, reasonable design and calculation for the structure is important for the safe operation of the whole heat exchanger. A ⅛ space model diagram and a 3D rendering diagram of the straight-section external guide cylinder are shown in FIGS. 3 and 4 respectively. Currently, it depends on the empirical method to design due to lack of an accurate scientific calculation method even in Chinese or other countries. The empirical method used isn't suitable for integrity safety evaluation of strength failure and safety status of the straight-section external guide cylinder. Meanwhile, the effect of the axial stiffness change is ignored at the shell side of the heat exchanger due to the external guide cylinder on the stress of the entire heat exchanger, which would lead to the engineering safety problems. Currently, the main problems existing in the design and calculation of the straight-section external guide cylinder with the internal distributor are as follows:

(1) Currently, empirical engineering methods are all based on the calculation of a circumferential stress of an outer shell under an internal pressure, which is namely a primary stress of the structure, that is, the stress of the cylinder body far from a discontinuous area. However, the straight-section external guide cylinder is of a discontinuous structure because the inner cylinder body, the outer cylinder body, the end plate and the internal distributor cylinder body interact with each other and undergo deformation coordination under loads such as the internal pressure and an axial force, which results in namely a secondary stress. Not only the secondary stress causes structural damage, but also an attenuation area of the secondary stress is related to the structural compactness of the straight-section external guide cylinder. (2) The elements in the straight-section external guide cylinder are welded at a right angle, joints between the inner cylinder body, the outer cylinder body, the end plate and the internal distributor cylinder body are of geometric catastrophe, and the structural discontinuity leads to a relatively high secondary stress. The high stress area is located at the welding area, which is the structurally dangerous part. Ignoring the evaluation of the dangerous part brings a potential safety hazard. (3) The straight-section external guide cylinder is designed by the rough empirical method, the thickness of the end plate is twice as thick as that of the outer cylinder body by means, which has no scientific formula basis, thereby being another potential safety hazard. (4) The total axial stiffness of the shell side of the heat exchanger directly affects the strength calculation of the tube sheet system including key elements such as tube sheets, a tube bundle, a shell-side cylinder body and the joints between the tube sheet and the tubes). The straight-section external guide cylinder obviously changes the axial stiffness of heat exchanger shell, but no relevant calculation method taking the above impact into account has been found yet.

### SUMMARY

An objective of the present disclosure is to provide a safety evaluation method and system for a straight-section external guide cylinder, and a correction method and system for a heat exchanger, to achieve the objective of accurately calculating and evaluating a strength and axial stiffness of the straight-section external guide cylinder and performing calculation and correction on a heat exchanger tube sheet system.

To achieve the above objective, the present disclosure provides the following solutions:

According to a first aspect, an embodiment of the present disclosure is to provide a safety evaluation method for a straight-section external guide cylinder, where the straight-section external guide cylinder is provided with an internal distributor, and includes four elements, namely, an inner cylinder body, an outer cylinder body, an end plate, and an internal distributor cylinder body. The safety evaluation method for the straight-section external guide cylinder includes: establishing a ½ symmetrical mechanical model based on symmetrical structural characteristics and real load conditions of the straight-section external guide cylinder, where the ½ symmetrical mechanical model includes an initial wall thickness of the inner cylinder body with an inner diameter of Rᵢ, an initial wall thickness of the outer cylinder body with an inner diameter of Rₒ, an initial wall thickness of the end plate connecting the inner cylinder body to the outer cylinder body, and an initial wall thickness of the internal distributor cylinder body with an inner diameter of Rᵢ; and the real load conditions include a medium internal pressure load and a set axial force load of the straight-section external guide cylinder; constructing a radial displacement formula and a rotation angle formula for each element in the straight-section external guide cylinder based on the ½ symmetrical mechanical model, where the radial displacement formula for each element in the straight-section external guide cylinder includes a radial displacement formula of the inner cylinder body at a connecting joint, a radial displacement formula of the outer cylinder body at the connecting joint, a radial displacement formula of the end plate at Rₜ, a radial displacement formula of the end plate at Rₒ, and a radial displacement formula of the internal distributor cylinder body at a connecting joint; and the rotation angle formula for each element in the straight-section external guide cylinder includes a rotation angle formula of the inner cylinder body at the connecting joint, a rotation angle formula of the outer cylinder body at the connecting joint, a rotation angle formula of the end plate at Rₜ, a rotation angle formula of the end plate at Rₒ, and a rotation angle formula of the internal distributor cylinder body at the connecting joint; constructing seventh-order matrix equations based on the radial displacement formula and the rotation angle formula for each element in the straight-section external guide cylinder, where the seven-order matrix equations represent a deformation coordination relationship and an interaction force relationship among the inner cylinder body, the outer cylinder body, the end plate and the internal distributor cylinder body in the straight-section external guide cylinder; calculating a stress at each position of each element in the straight-section external guide cylinder based on a solution of the seven-order matrix equations, where the stress includes a bending stress and a membrane stress of the outer cylinder body, a bending stress and a membrane stress of the end plate, a bending stress and a membrane stress of the inner cylinder body, and a bending stress and a membrane stress of the internal distributor cylinder body; the bending stress of each cylinder body includes a circumferential bending stress and a meridional bending stress; the membrane stress of the cylinder body includes a circumferential membrane stress and a meridional membrane stress; the cylinder body includes the outer cylinder body, the inner cylinder body, and the internal distributor cylinder body; the bending stress of the end plate includes a circumferential bending stress and a radial bending stress; the membrane stress of the end plate includes a circumferential membrane stress and a radial membrane stress; and determining a maximum stress of each element in the straight-section external guide cylinder based on the stress at each position of each element in the straight-section external guide cylinder, and performing strength evaluation on the element in the straight-section external guide cylinder based on the maximum stress of each element in the straight-section external guide cylinder, to determine a final wall thickness of each element, where the maximum stress includes a maximum bending stress and a maximum membrane stress.

According to a second aspect, an embodiment of the present disclosure provides a correction method for a heat exchanger system, including: the safety evaluation method for the straight-section external guide cylinder according to the first aspect; calculating axial stiffness of the straight-section external guide cylinder based on a final wall thickness of each element; correcting the heat exchanger system based on the axial stiffness of the straight-section external guide cylinder to obtain a correction result of the heat exchanger system, where the correction result of the heat exchanger system includes a tube sheet correction result, a tube bundle correction result, a tube sheet and heat exchange tube joint correction result, and a shell-side cylinder body correction result; calculating an axial force of a shell-side cylinder body in the heat exchanger system based on the correction result of the shell-side cylinder body, applying the axial force of the shell-side cylinder body to an end portion of the inner cylinder body of the straight-section external guide cylinder, and performing strength calculation together with the medium internal pressure load to update a maximum stress of each element in the straight-section external guide cylinder, where the axial force of the shell-side cylinder body is a calculated axial force load of the straight-section external guide cylinder; and performing strength evaluation on the element in the straight-section external guide cylinder based on an updated maximum stress of each element in the straight-section external guide cylinder, and updating the final wall thickness of each element.

According to a third aspect, an embodiment of the present disclosure is to provide a safety evaluation system for a straight-section external guide cylinder, where the straight-section external guide cylinder is provided with an internal distributor, and includes four elements, namely, an inner cylinder body, an outer cylinder body, an end plate, and an internal distributor cylinder body, and the safety evaluation system for a straight-section external guide cylinder includes: a ½ symmetrical mechanical model building module, configured to establish a ½ symmetrical mechanical model based on symmetrical structural characteristics and real load conditions of the straight-section external guide cylinder, where the ½ symmetrical mechanical model includes an initial wall thickness of the inner cylinder body with an inner diameter of Rᵢ, an initial wall thickness of the outer cylinder body with an inner diameter of Rₒ, an initial wall thickness of the end plate connecting the inner cylinder body to the outer cylinder body, and an initial wall thickness of the internal distributor cylinder body with an inner diameter of Rᵢ; and the real load conditions include a medium internal pressure load and a set axial force load of the straight-section external guide cylinder; a formula construction module, configured to construct a radial displacement formula and a rotation angle formula for each element in the straight-section external guide cylinder based on the ½ symmetrical mechanical model, where the radial displacement formula for each element in the straight-section external guide cylinder includes a radial displacement formula of the inner cylinder body at a connecting joint, a radial displacement formula of the outer cylinder body at a connecting joint, a radial displacement formula of the end plate at Rₜ, a radial displacement formula of the end plate at Rₒ, and a radial displacement formula of the internal distributor cylinder body at a connecting joint; and the rotation angle formula for each element in the straight-section external guide cylinder includes a rotation angle formula of the inner cylinder body at the connecting joint, a rotation angle formula of the outer cylinder body at the connecting joint, a rotation angle formula of the end plate at Rₜ, a rotation angle formula of the end plate at Rₒ, and a rotation angle formula of the internal distributor cylinder body at the connecting joint; a matrix equation establishing module, configured to construct seven-order matrix equations based on the radial displacement formula and the rotation angle formula for each element in the straight-section external guide cylinder, where the seven-order matrix equations represent a deformation coordination relationship and an interaction force relationship among the inner cylinder body, the outer cylinder body, the end plate and the internal distributor cylinder body in the straight-section external guide cylinder; a stress calculation module, configured to calculate a stress at each position of each element in the straight-section external guide cylinder based on a solution of the seven-order matrix equations, where the stress includes a bending stress and a membrane stress of the outer cylinder body, a bending stress and a membrane stress of the end plate, a bending stress and a membrane stress of the inner cylinder body, and a bending stress and a membrane stress of the internal distributor cylinder body; the bending stress of each cylinder body includes a circumferential bending stress and a meridional bending stress; the membrane stress of the cylinder body includes a circumferential membrane stress and a meridional membrane stress; the cylinder body includes the outer cylinder body, the inner cylinder body, and the internal distributor cylinder body; the bending stress of the end plate includes a circumferential bending stress and a radial bending stress; the membrane stress of the end plate includes a circumferential membrane stress and a radial membrane stress; and a final wall thickness calculation module, configured to determine a maximum stress of each element in the straight-section external guide cylinder based on the stress at each position of each element in the straight-section external guide cylinder, and perform strength evaluation on the element in the straight-section external guide cylinder based on the maximum stress of each element in the straight-section external guide cylinder, to determine a final wall thickness of each element, where the maximum stress includes a maximum bending stress and a maximum membrane stress.

According to a fourth aspect, an embodiment of the present disclosure provides a correction system for a heat exchanger system, including: a safety evaluation system for a straight-section external guide cylinder, where the safety evaluation system for a straight-section external guide cylinder is a system determined by means of the safety evaluation method for the straight-section external guide cylinder according to the first aspect; an axial stiffness calculation module, configured to calculate axial stiffness of the straight-section external guide cylinder based on a final wall thickness of each element; a heat exchanger system correction module, configured to correct the heat exchanger system based on the axial stiffness of the straight-section external guide cylinder to obtain a correction result of the heat exchanger system, where the correction result of the heat exchanger system includes a tube sheet correction result, a tube bundle correction result, a tube sheet and heat exchange tube joint correction result, and a shell-side cylinder body correction result; a maximum stress update module, configured to calculate an axial force of a shell-side cylinder body in the heat exchanger system based on the correction result of the shell-side cylinder body, apply the axial force of the shell-side cylinder body to an end portion of the inner cylinder body of the straight-section external guide cylinder, and perform strength calculation together with the medium internal pressure load to update a maximum stress of each element in the straight-section external guide cylinder, where the axial force of the shell-side cylinder body is a calculated axial force load of the straight-section external guide cylinder; and a final wall thickness update module, configured to perform strength evaluation on the element in the straight-section external guide cylinder based on an updated maximum stress of each element in the straight-section external guide cylinder, and update the final wall thickness of each element.

According to specific embodiments of the present disclosure, the present disclosure discloses the following technical effects:

According to the present disclosure, based on real load conditions and a geometric model, and taking the impact of a discontinuous structure boundary into account, a mechanical model is established, and an accurate analytical mechanical solution is deduced based on the theory of plates and shells, thereby solving existing problems, filling the technical gaps at home and abroad, and eliminating potential safety hazards. According to the present disclosure, accurate calculation formulas are put forward to calculate biaxial stresses of four substantially stressed elements and safety evaluation is provided, which provides a more scientific and accurate calculation method for the design and calculation of a straight-section external guide cylinder itself and a heat exchanger. According to the present disclosure, a seven-order linear equation set is formed finally by mathematical transformation, thereby making it easy to perform programming and software implementation, and providing strong guarantee for design optimization and production safety.

### BRIEF DESCRIPTION OF THE DRAWINGS

To describe the technical solutions in embodiments of the present disclosure or in the prior art more clearly, the accompanying drawings required in the embodiments are briefly described below. Apparently, the accompanying drawings in the following description show merely some embodiments of the present disclosure, and other accompanying drawings can be further derived from these accompanying drawings by a person of ordinary skill in the art without creative efforts.

FIG. 1 is an actual outline diagram of a straight-section external guide cylinder used in a heat exchanger;

FIG. 2 is a schematic diagram of parts of a straight-section external guide cylinder and a connection relationship thereof;

FIG. 3 is a ⅛ space model diagram of a straight-section external guide cylinder;

FIG. 4 is a three-dimensional (3D) rendering diagram of a straight-section external guide cylinder;

FIG. 5 is a schematic diagram of a ½ symmetrical mechanical model of a straight-section external guide cylinder according to the present disclosure;

FIG. 6 is a schematic flowchart of a safety evaluation method for a straight-section external guide cylinder according to the present disclosure;

FIG. 7 is a cross-sectional view of an internal distributor cylinder body at a symmetry plane; and

FIG. 8 is a schematic structural diagram of an axial stiffness system of a straight-section external guide cylinder according to the present disclosure.

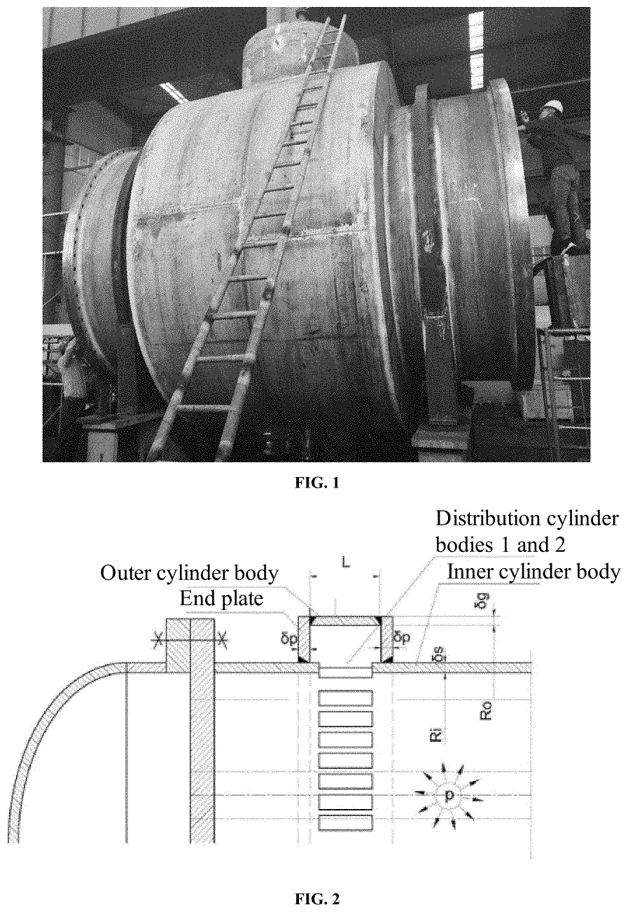

### DETAILED DESCRIPTION OF THE EMBODIMENTS

The technical solutions of the embodiments of the present disclosure are clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

Safety evaluation for a straight-section external guide cylinder involves strength and stiffness. The thickness of each element in the straight-section external guide cylinder is first determined by strength calculation. Currently, the thickness is generally determined by means of a semi-empirical method: A designer generally calculates a thickness δ1 of an outer cylinder body by means of an internal pressure first, and a thickness of an end plate is δ₂=2*δ₁. The stiffness of the straight-section external guide cylinder mainly affects calculation results of a tube sheet and a tube bundle of a heat exchanger, but the stiffness is often ignored currently. The design and calculation are too simplified and rough, so that it is impossible to objectively evaluate the strength failure and safety status of the straight-section external guide cylinder, and the neglect or unscientific calculation of axial stiffness causes potential safety hazards to the entire heat exchanger. Therefore, the present disclosure provides a corresponding technical solution to solve the problem of difficulty in design and calculation of a straight-section external guide cylinder with an internal distributor in a shell-and-tube heat exchanger with a high pressure and a large diameter.

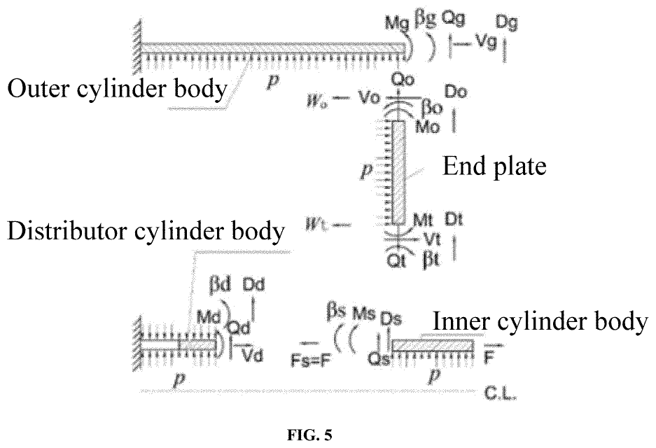

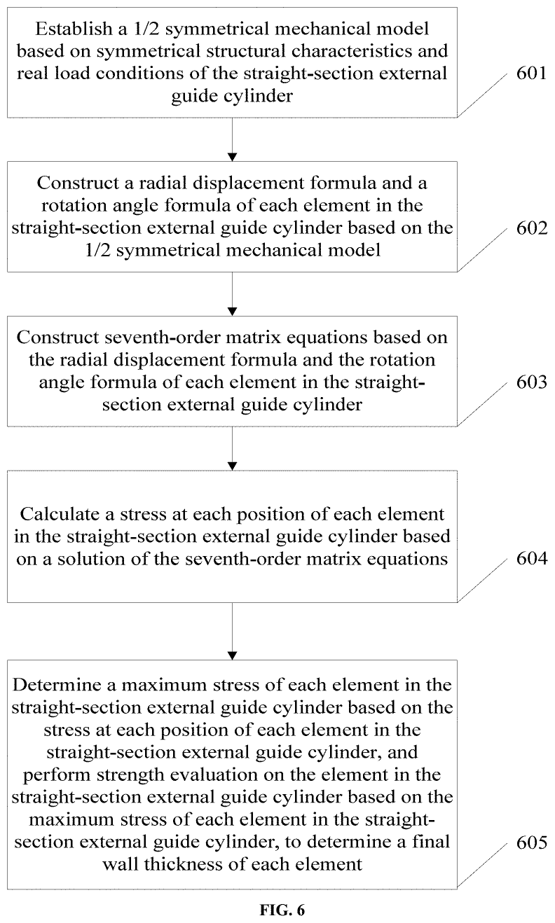

According to the present disclosure, based on real load conditions and a geometric model, and taking the impact of a weakened position of an opening area of the internal distributor and the deformation coordination of the discontinuous structure of the internal distributor and other elements into account, a mechanical model is established (see FIG. 5), and an accurate analytical elastic mechanical analytical solution is deduced based on the theory of plates and shells, thereby solving existing problems, filling the technical gaps at home and abroad, effectively guiding the design, and eliminating potential safety hazards.

The straight-section external guide cylinder according to the present disclosure includes four elements, namely, an end plate, an outer cylinder body, an inner cylinder body, and an internal distributor cylinder body. Embodiments of the present disclosure provide a method for accurate strength calculation of each element, a method for calculating axial stiffness of a straight-section external guide cylinder, and a method for calculating a stress of each stressed element of a heat exchanger considering axial stiffness of a straight-section external guide cylinder, and provide a safety criterion, thereby providing a complete and accurate calculation method for the straight-section external guide cylinder itself and the design and calculation of the heat exchanger. According to the present disclosure, a seven-order linear equation matrix is formed finally by mathematical transformation, thereby making it easy to perform programming and software implementation, and providing strong guarantee for design optimization and production safety.

The safety evaluation according to the embodiments of the present disclosure mainly includes: (1) Radial or meridional and circumferential stresses of each element in the straight-section external guide cylinder and their corresponding strength failure criteria are provided in the present disclosure; (2) a method for calculating axial stiffness of a straight-section external guide cylinder is provided in the present disclosure; and (3) a method for performing calculation and correction on a fixed tube-sheet heat exchanger with a straight-section external guide cylinder on a shell side is provided in the present disclosure.

In addition, according to the embodiments of the present disclosure, a stress attenuation trend curve of each stressed element can be obtained and used for the arrangement of adjacent elements, proving that the calculated trend attenuation curve according to the present disclosure is far smaller than 2.5\sqrt{RT} given based on the current Saint-Venant principle. The calculation results according to the embodiments of the present disclosure are more practical and more conducive to a compact structure design.

### Embodiment 1

This embodiment of the present disclosure provides a safety evaluation method for a straight-section external guide cylinder, where the straight-section external guide cylinder includes an inner cylinder body, an outer cylinder body, an end plate, and an internal distributor cylinder body. As shown in FIG. 6, the method includes the following steps.

Step 601: Establish a ½ symmetrical mechanical model based on symmetrical structural characteristics and real load conditions of the straight-section external guide cylinder, where the ½ symmetrical mechanical model includes an initial wall thickness of the inner cylinder body with an inner diameter of Rᵢ, an initial wall thickness of the outer cylinder body with an inner diameter of Rₒ, an initial wall thickness of the end plate connecting the inner cylinder body to the outer cylinder body, and an initial wall thickness of the internal distributor cylinder body with an inner diameter of Rᵢ; and the real load conditions include a medium internal pressure load and a set axial force load of the straight-section external guide cylinder. This step specifically includes the following steps.

Step 1: According to design conditions (design pressure, design temperature, material, dimensions, etc.) of the straight-section external guide cylinder, calculate, based on a semi-empirical method, initial wall thicknesses of the four elements, i.e., a wall thickness δₛ of the inner cylinder body, a wall thickness δ_{g} of the outer cylinder body, a wall thickness δₚ of the end plate, and a wall thickness δ_{d} of the internal distributor cylinder body.

In the semi-empirical method, the internal pressure is a known calculation condition, and δₛ and δ_{g} are calculated based on an internal pressure calculation formula in the standard GB/T150.3-2011, and are the wall thickness δₛ of the inner cylinder body and the wall thickness δ_{g} of the outer cylinder body as the initial wall thicknesses. The wall thickness of the internal distributor cylinder body is δ_{d}, and δ_{d}=δₛ is generally taken as an initial wall thickness; and the wall thickness of the end plate is δₚ=2δ_{g} as an initial wall thickness. Based on the above initial wall thicknesses, the wall thickness can be optimized according to the present disclosure, to obtain the final wall thickness of the above element.

Step 2: Establish the ½ symmetrical mechanical model based on the symmetrical structural characteristics of the straight-section external guide cylinder, the initial wall thickness of the inner cylinder body, the initial wall thickness of the outer cylinder body, the initial wall thickness of the end plate, and the initial wall thickness of the internal distributor cylinder body, where a symmetry plane is located at a part (½)L, and force elements (a force and a bending moment) between elements in the ½ symmetric mechanical model are specifically shown in FIG. 5. L is a length of the outer cylinder body.

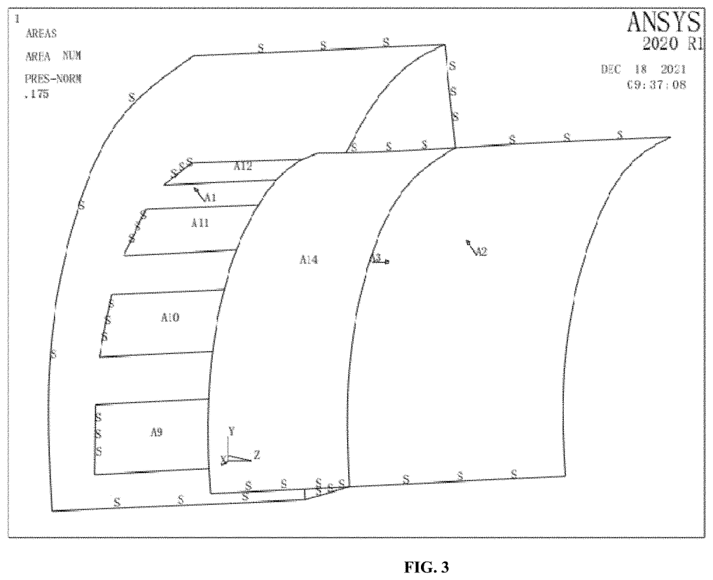

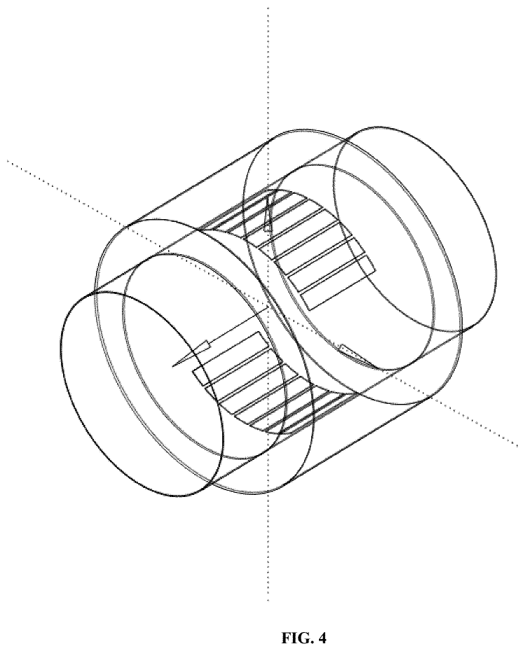

In the ½ symmetrical mechanical model, the straight-section external guide cylinder is divided into four interacting substantially-independent stressed elements, i.e., the inner cylinder body with an inner diameter of Rᵢ, the outer cylinder body with an inner diameter of Rₒ and a length of 0.5 L, the end plate connecting the inner cylinder body to the outer cylinder body, and the internal distributor cylinder body with an inner diameter of Rᵢ. As shown in FIG. 3, a coil position is weakened positions of openings. The objective of forming these openings in the internal distributor cylinder body is to provide a distribution channel for fluid, but due to the reduction of materials, the opening area may affect the strengthening function of axial tension, in other words, the axial stiffness is weakened. In order to solve the weakening impact caused by the openings in the internal distributor cylinder body, a material elastic modulus weakening coefficient ϕ is introduced for representation. ϕ is a ratio of the sum of a cross-sectional area of the openings to a total cross-sectional area, i.e.,

$$ϕ = \frac{{\sum }_{i = 1}^{n} {A}_{i}}{{\sum }_{i = 1}^{n} {A}_{i} + {A}_{L}} .$$

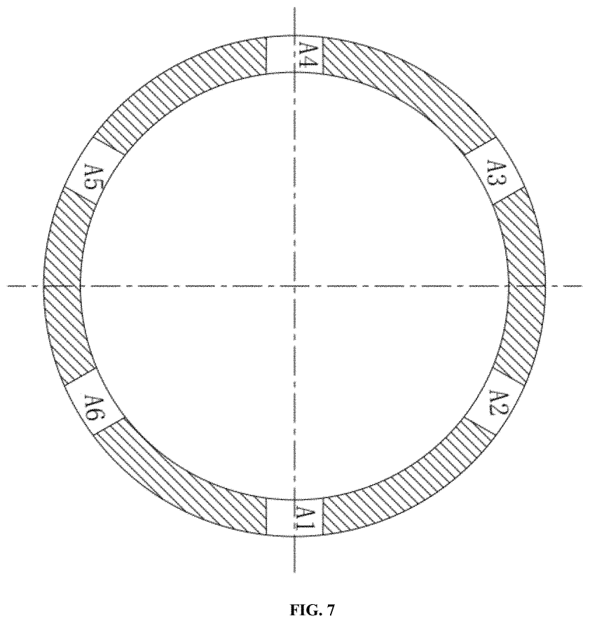

As shown in FIG. 7, Aᵢ is the cross-sectional area of the i^{th} opening, and referring to a non-shaded area in FIG. 7, n is the number of the openings, and is determined by the designer. Taking what is shown in FIG. 7 as an example, i=6 in the figure. A_{L} is the remaining area of the openings, referring to the shaded area in FIG. 7. The four elements are expressed by the equivalent bending moment and force, and denoted by force element symbols, specifically as shown in FIG. 5. The symbol description is shown in Table 1.

TABLE 1
Symbol description

| | |
|---|---|
| L | Axial length of the outer cylinder body, mm |
| p | Internal pressure, MPa |
| k_{d} | $\begin{matrix}Coefficient of the internal distributor cylinder body shell = \\ \sqrt[4]{3 ( 1 - {v}_{d}^{2} )} / \sqrt{{R}_{d} {δ}_{d}} , 1 / mm\end{matrix}$ |
| k_{g} | $\begin{matrix}Coefficient of the outer cylinder body shell = \\ \sqrt[4]{3 ( 1 - {v}_{g}^{2} )} / \sqrt{{R}_{g} {δ}_{g}} , 1 / mm\end{matrix}$ |
| kₛ | $\begin{matrix}Coefficient of the inner cylinder body shell = \\ \sqrt[4]{3 ( 1 - {v}_{s}^{2} )} / \sqrt{{R}_{s} {δ}_{s}} , 1 / mm\end{matrix}$ |
| M_{g} | Bending moment per unit circumference at a connecting joint |
| | between the outer cylinder body and the end plate, N · mm/mm |
| Mₒ | Bending moment per unit circumference at a connecting joint (Rₒ) |
| | between the end plate and the outer cylinder body, N · mm/mm |
| Mₛ | Bending moment per unit circumference at a connecting joint |
| | between the inner cylinder body and the end plate, N · mm/mm |
| Mₜ | Bending moment per unit circumference at a connecting joint (Rₜ) |
| | between the end plate and the inner cylinder body, N · mm/mm |
| Q_{g} | Radial force per unit circumference at the connecting joint between |
| | the outer cylinder body and the end plate, N/mm |
| Qₒ | Radial force per unit circumference at the connecting joint (Rₒ) |
| | between the end plate and the outer cylinder body, N/mm |
| Qₛ | Radial force per unit circumference at the connecting joint between |
| | the inner cylinder body and the end plate, N/mm |
| Qₜ | Radial force per unit circumference at the connecting joint (Rₜ) |
| | between the end plate and the inner cylinder body, N/mm |
| V_{g} | Radial unit force acting on the outer cylinder body, N/mm |
| Vₒ | Unit shear force acting on the end plate (Rₒ), N/mm |
| Vₜ | Unit shear force acting on the end plate (Rₜ), N/mm |
| Wₒ | Axial displacement of the end plate (Rₒ), mm |
| Wₜ | Axial displacement of the end plate (Rₒ), mm |
| β_{g} | Rotation angle at the connecting joint between the outer cylinder |
| | body and the end plate, Rad |
| βₒ | Rotation angle of the end plate at Rₒ, Rad |
| βₜ | Rotation angle of the end plate at Rₜ, Rad |
| βₛ | Rotation angle at the connecting joint between the inner cylinder |
| | body and the end plate, Rad |
| vₛ | Poisson's ratio of the inner cylinder body material, dimensionless, |
| | whose value is searched for from Material Performance Manual |
| v_{g} | Poisson's ratio of the outer cylinder body material, dimensionless, |
| | whose value is searched for from Material Performance Manual |
| vₚ | Poisson's ratio of the end plate material, dimensionless, whose |
| | value is searched for from Material Performance Manual |

Step 602: Construct a radial displacement formula and a rotation angle formula for each element in the straight-section external guide cylinder based on the ½ symmetrical mechanical model, where the radial displacement formula for each element in the straight-section external guide cylinder includes a radial displacement formula of the inner cylinder body at a connecting joint, a radial displacement formula of the outer cylinder body at a connecting joint, a radial displacement formula of the end plate at Rₜ, a radial displacement formula of the end plate at Rₒ, and a radial displacement formula of the internal distributor cylinder body at a connecting joint; and the rotation angle formula for each element in the straight-section external guide cylinder includes a rotation angle formula of the inner cylinder body at the connecting joint, a rotation angle formula of the outer cylinder body at the connecting joint, a rotation angle formula of the end plate at Rₜ, a rotation angle formula of the end plate at Rₒ, and a rotation angle formula of the internal distributor cylinder body at the connecting joint. Rₜ represents an inner diameter of the end plate.

Under the action of the internal pressure and an edge load, the radial displacement formula of the inner cylinder body at the connecting joint is as follows:

$${D}_{s} = \frac{2 {k}_{s} \cdot {R}_{ms}^{2}}{{E}_{s} \cdot {δ}_{s}} {Q}_{s} + \frac{2 {k}_{s}^{2} \cdot {R}_{ms}^{2}}{{E}_{s} \cdot {δ}_{s}} {M}_{s} + \frac{{R}_{ms}^{2}}{{E}_{s} \cdot {δ}_{s}} ( 1 - 0.5 {v}_{s} ) \cdot p , \qquad ( 1 )$$

where Eₛ is an elastic modulus of the inner cylinder body material, in MPa; Rₘₛ is a middle plane radius of the inner cylinder body shell, in mm, and Rₘₛ=Rᵢ+0.5δs.

Under the action of the edge load, the rotation angle formula of the inner cylinder body at the connecting joint is as follows:

$${β}_{s} = \frac{2 {k}_{s}^{2} \cdot {R}_{ms}^{2}}{{E}_{s} \cdot {δ}_{s}} {Q}_{s} + \frac{4 {k}_{s}^{3} \cdot {R}_{ms}^{2}}{{E}_{s} \cdot {δ}_{s}} {M}_{s} . \qquad ( 2 )$$

The radial displacement formula of the end plate at Rₜ is as follows:

$${D}_{t} = \frac{2 \cdot {ρ}_{t} \cdot {R}_{o}}{{E}_{p} \cdot {δ}_{p} \cdot ( 1 - {ρ}_{t}^{2} )} {Q}_{o} - \frac{{ρ}_{t} \cdot {R}_{o}}{{E}_{p} \cdot {δ}_{p}} ( \frac{1 + {ρ}_{t}^{2}}{1 - {ρ}_{t}^{2}} + {v}_{p} ) {Q}_{t} , \qquad ( 3 )$$

where Eₚ is an elastic modulus of the end plate material, in MPa; and ρₜ=Rₜ/Rₒ.

The radial displacement formula of the end plate at Rₒ is as follows:

$${D}_{o} = - \frac{2 \cdot {R}_{o} \cdot {ρ}_{t}^{2}}{{E}_{p} \cdot {δ}_{p} \cdot ( 1 - {ρ}_{1}^{2} )} {Q}_{1} + \frac{{R}_{o}}{{E}_{p} \cdot {δ}_{p}} ( \frac{1 + {ρ}_{1}^{2}}{1 - {ρ}_{1}^{2}} - {v}_{p} ) {Q}_{o} . \qquad ( 4 )$$

The rotation angle formula of the end plate at Rₜ is as follows:

$${β}_{t} = \frac{{R}_{o}}{{D}_{p} \cdot {K}_{tR}} {M}_{o} - \frac{{R}_{o} \cdot {ρ}_{t}}{{D}_{p} \cdot {K}_{tt}} {M}_{t} - \frac{{R}_{o}^{2} \cdot {ρ}_{t}}{{D}_{p} \cdot {K}_{tV}} {V}_{t} - \frac{{R}_{o}^{3}}{{D}_{p} \cdot {K}_{tp}} p , \qquad ( 5 )$$

where K_{tR}, Kₜₜ, K_{tV}, K_{tP} and Dₚ are end plate calculation coefficients, and are related to the geometric size of the end plate. See standard JB4732.

The rotation angle formula of the end plate at Rₒ is as follows:

$${β}_{o} = - \frac{{R}_{o}}{{D}_{p} \cdot {K}_{RR}} {M}_{o} + \frac{{R}_{o} \cdot {ρ}_{t}}{{D}_{p} \cdot {K}_{Rt}} {M}_{t} + \frac{{R}_{o}^{2} \cdot {ρ}_{t}}{{D}_{p} \cdot {K}_{RV}} {V}_{t} + \frac{{R}_{o}^{3}}{{D}_{p} \cdot {K}_{Rp}} p , \qquad ( 6 )$$

where K_{RR}, K_{Rt}, K_{RV} and K_{Rp} are end plate calculation coefficients, and are related to the geometric size of the end plate. See standard JB4732.

Under the action of the internal pressure and the edge load, the radial displacement formula of the outer cylinder body at the connecting joint is as follows:

$${D}_{g} = \frac{2 {k}_{g} \cdot {R}_{mg}^{2}}{{E}_{g} \cdot {δ}_{g}} {Q}_{g} + \frac{2 {k}_{g}^{2} \cdot {R}_{mg}^{2}}{{E}_{g} \cdot {δ}_{g}} {M}_{g} + \frac{{R}_{mg}^{2}}{{E}_{g} \cdot {δ}_{g}} ( 1 - 0.5 {v}_{g} ) \cdot p , \qquad ( 7 )$$

where E_{g} is an elastic modulus of the outer cylinder body material, in MPa; R_{mg} is a middle plane radius of the outer cylinder body shell, in mm, and R_{mg}=Rₒ+0.5δ_{g}.

Under the action of the edge load, the rotation angle formula of the outer cylinder body at the connecting joint is as follows:

$${β}_{g} = \frac{2 {k}_{g}^{2} \cdot {R}_{mg}^{2}}{{E}_{g} \cdot {δ}_{g}} {Q}_{g} + \frac{4 {k}_{g}^{3} \cdot {R}_{mg}^{2}}{{E}_{g} \cdot {δ}_{g}} {M}_{g} . \qquad ( 8 )$$

Under the action of the internal pressure and the edge load, the radial displacement formula of the internal distributor cylinder body at the connecting joint is as follows:

$${D}_{d} = \frac{2 {k}_{d} \cdot {R}_{md}^{2}}{{E}_{d} \cdot {δ}_{d}} {Q}_{d} + \frac{2 {d}_{d}^{2} \cdot {R}_{md}^{2}}{{E}_{d} \cdot {δ}_{d}} {M}_{d} , \qquad ( 9 )$$

where E_{d} is an elastic modulus of the internal distributor cylinder body material, in MPa; R_{md} is a middle plane radius of the internal distributor cylinder body shell, in mm, and R_{md}+Rₜ+0.5δ_{d}.

Under the action of the edge load, the rotation angle formula of the internal distributor cylinder body at the connecting joint is as follows:

$${β}_{d} = \frac{2 {k}_{d}^{2} \cdot {R}_{md}^{2}}{{E}_{d} \cdot {δ}_{d}} {Q}_{d} + \frac{4 {k}_{d}^{3} \cdot {R}_{md}^{2}}{{E}_{d} \cdot {δ}_{d}} {M}_{d} . \qquad ( 10 )$$

Step 603: Construct seven-order matrix equations based on the radial displacement formula and the rotation angle formula for each element in the straight-section external guide cylinder, where the seven-order matrix equations represent a deformation coordination relationship and an interaction force relationship among the inner cylinder body, the outer cylinder body, the end plate and the internal distributor cylinder body in the straight-section external guide cylinder.

From the relationship between acting forces and reactions in FIG. 5, six unknown quantities, Q₁, Q₂, Q₃, M₁, M₂ and M₃, are introduced, and the following can be obtained from the action relationship between elements: Q₁=Qₜ; Q₂=Q_{g}=−Qₒ; Q₃=Qₛ; Q_{d}=Qₜ−Qₛ=Q₁−Q₃; M₁=Mₜ; M₂=Mₒ=M_{g}; M₃=Mₛ; and M_{d}=Mₛ−Mₜ=M₃−M₁.

Formulas (11)-(16) can be derived based on formulas (1)-(10) and a displacement mechanical relationship:

Formula (11) is obtained from Dₛ=Dₜ:

$$( \frac{{ρ}_{t} \cdot {R}_{o}}{{E}_{p} \cdot {δ}_{p}} ( \frac{1 + {ρ}_{t}^{2}}{1 - {ρ}_{t}^{2}} + {v}_{p} ) ) {Q}_{1} + \frac{2 \cdot {ρ}_{t} \cdot {R}_{o}}{{E}_{p} \cdot {δ}_{p} \cdot ( 1 - {ρ}_{t}^{2} )} {Q}_{2} + \frac{2 {k}_{s} \cdot {R}_{ms}^{2}}{{E}_{s} \cdot {δ}_{s}} {Q}_{3} + \frac{2 {k}_{s}^{2} \cdot {R}_{ms}^{2}}{{E}_{s} \cdot {δ}_{s}} {M}_{3} = - \frac{{R}_{ms}^{2}}{{E}_{s} \cdot {δ}_{s}} ( 1 - 0.5 {v}_{s} ) \cdot p . \qquad ( 11 )$$

Formula (12) is obtained from Dₛ=D_{d}:

$$- \frac{2 {k}_{d} \cdot {R}_{md}^{2}}{{E}_{d} \cdot {δ}_{d}} {Q}_{1} + ( \frac{2 {k}_{s} \cdot {R}_{ms}^{2}}{{E}_{s} \cdot {δ}_{s}} + \frac{2 {k}_{d} \cdot {R}_{ms}^{2}}{{E}_{d} \cdot {δ}_{d}} ) {Q}^{3} + \frac{2 {k}_{d}^{2} \cdot {R}_{md}^{2}}{{E}_{d} \cdot {δ}_{d}} {M}_{1} + ( \frac{2 {k}_{s}^{2} \cdot {R}_{ms}^{2}}{{E}_{s} \cdot {δ}_{ss}} - \frac{2 {k}_{d}^{2} \cdot {R}_{md}^{2}}{{E}_{d} \cdot {δ}_{d}} ) {M}_{3} = - \frac{{R}_{ms}^{2}}{{E}_{s} \cdot {δ}_{s}} ( 1 - 0.5 {v}_{s} ) \cdot p . \qquad ( 12 )$$

Formula (13) is obtained from Dₒ=D_{g}:

$$- \frac{2 \cdot {R}_{o} \cdot {ρ}_{t}^{2}}{{E}_{p} \cdot {δ}_{p} \cdot ( 1 - {ρ}_{t}^{2} )} {Q}_{1} - ( \frac{{R}_{o}}{{E}_{p} \cdot {δ}_{p}} ( \frac{1 + {ρ}_{t}^{2}}{1 - {ρ}_{t}^{2}} - {v}_{p} ) + \frac{2 {k}_{g} \cdot {R}_{mg}^{2}}{{E}_{g} \cdot {δ}_{g}} ) {Q}_{2} - \frac{2 {k}_{g}^{2} \cdot {R}_{mg}^{2}}{{E}_{g} \cdot {δ}_{g}} {M}_{2} = \frac{{R}_{mg}^{2}}{{E}_{g} \cdot {δ}_{g}} ( 1 - 0.5 {v}_{g} ) \cdot p . \qquad ( 13 )$$

Formula (14) is obtained from βₛ=βₜ:

$$\frac{2 {k}_{s}^{2} \cdot {R}_{ms}^{2}}{Es \cdot δ s} {Q}_{3} + \frac{{R}_{o} \cdot {ρ}_{t}}{{D}_{p} \cdot {K}_{tt}} {M}_{1} - \frac{{R}_{o}}{{D}_{p} \cdot {K}_{tR}} {M}_{2} + \frac{4 {k}_{s}^{3} \cdot {R}_{ms}^{2}}{Es \cdot δ s} {M}_{3} + \frac{{R}_{o}^{2} \cdot {ρ}_{t}}{{D}_{p} \cdot {K}_{tV}} {V}_{t} = - \frac{{R}_{o}^{3}}{{D}_{p} \cdot {K}_{tp}} p . \qquad ( 14 )$$

Formula (15) is obtained from βₛ=−β_{d}:

$$\frac{2 {k}_{d}^{2} \cdot {R}_{md}^{2}}{{E}_{d} \cdot {δ}_{d}} {Q}_{1} + ( \frac{2 {k}_{s}^{2} \cdot {R}_{ms}^{2}}{{E}_{s} \cdot {δ}_{s}} - \frac{2 {k}_{d}^{2} \cdot {R}_{md}^{2}}{{E}_{d} \cdot {δ}_{d}} ) {Q}_{3} - \frac{4 {k}_{d}^{3} \cdot {R}_{md}^{2}}{{E}_{d} \cdot {δ}_{d}} {M}_{1} + ( \frac{4 {k}_{s}^{3} \cdot {R}_{ms}^{2}}{{E}_{s} \cdot {δ}_{s}} + \frac{4 {k}_{d}^{3} \cdot {R}_{md}^{2}}{{E}_{d} \cdot {δ}_{d}} ) {M}_{3} = 0. \qquad ( 15 )$$

Formula (16) is obtained from β₀=β_{g}:

$$- \frac{2 {k}_{g}^{2} \cdot {R}_{mg}^{2}}{{E}_{g} \cdot {δ}_{g}} {Q}_{2} + \frac{{R}_{o} \cdot {ρ}_{t}}{{D}_{p} \cdot {K}_{Rt}} {M}_{t} - ( \frac{{R}_{o}}{{D}_{p} \cdot {K}_{RR}} + \frac{4 {k}_{g}^{3} \cdot {R}_{mg}^{2}}{{E}_{g} \cdot {δ}_{g}} ) {M}_{2} + \frac{{R}_{o}^{2} \cdot {ρ}_{t}}{{D}_{p} \cdot {K}_{RV}} {V}_{t} = - \frac{{R}_{o}^{3}}{{D}_{p} \cdot {K}_{Rp}} p . \qquad ( 16 )$$

Formula (17) is obtained from W_{d}=W_{g}+ΔWₚ:

$$\frac{{R}_{o}^{2}}{{D}_{p}} \frac{{ρ}_{t}}{{K}_{VT}} \cdot {M}_{1} - \frac{{R}_{o}^{2}}{{D}_{p}} \cdot \frac{1}{{K}_{VR}} \cdot {M}_{2} + ( \frac{{L}_{g} \cdot {ρ}_{t}}{2 \cdot {E}_{g} \cdot {δ}_{g}} + \frac{{ρ}_{t} \cdot {R}_{o}^{3}}{{D}_{p} \cdot {K}_{VV}} + \frac{{L}_{g} + ( \frac{1}{ϕ} - 1 ) {L}_{belt}}{2 \cdot {E}_{d} \cdot {δ}_{d}} ) \cdot {V}_{t} = \frac{F}{2 \cdot {E}_{d} \cdot {δ}_{d}} \cdot [ {L}_{g} + ( \frac{1}{ϕ} - 1 ) {L}_{belt} ] - \frac{{L}_{g} \cdot p}{2 \cdot {E}_{g} \cdot {δ}_{g}} \cdot ( 0.5 \cdot {R}_{o} ( 1 - {ρ}_{t}^{2} ) - {R}_{mg} \cdot {v}_{g} ) - \frac{{R}_{o}^{4} \cdot p}{{D}_{p} \cdot {K}_{Vp}} , \qquad ( 17 )$$

where W_{d} is axial displacement of an end portion of the internal distributor cylinder body, in mm; W_{g} is axial displacement of an end portion of the outer cylinder body, in mm; and ΔWₚ is an axial displacement difference at an inner/outer radius (Rₜ and Rₒ) of the end plate, in mm.

The seven-order matrix equations are constructed from formulas (11)-(17), and the form is shown in formula (18):

$$\begin{matrix}{\sum }_{j = 1}^{7} {F}_{ij} {x}_{j} = {F}_{ip} & i = 1 , 2 , … 7\end{matrix} \\ \{ {x}_{j} \} = \{ {Q}_{1} , {Q}_{2} , {Q}_{3} , {M}_{1} , {M}_{2} , {M}_{3} , {V}_{t} \} . \qquad ( 18 )$$

Formula (19) and formula (20) can be obtained from the mechanical relationship among Vₜ, V_{d}, Vₒ, and V_{g}.

V_{d}=F−Vₜ (19).

Vₒ=V_{g}=Vₜ·ρₜ+0.5p·Rₒ(1−ρₜ²) (20).

V_{d} is the axial force per unit circumference at the end portion of the internal distributor cylinder body, as shown in FIG. 5, in N/mm.

Step 604: Calculate a stress at each position of each element in the straight-section external guide cylinder based on a solution of the seven-order matrix equations, where the stress includes a bending stress and a membrane stress of the outer cylinder body, a bending stress and a membrane stress of the end plate, a bending stress and a membrane stress of the inner cylinder body, and a bending stress and a membrane stress of the internal distributor cylinder body; the bending stress of each cylinder body includes a circumferential bending stress and a meridional bending stress; the membrane stress of the cylinder body includes a circumferential membrane stress and a meridional membrane stress; the cylinder body includes the outer cylinder body, the inner cylinder body, and the internal distributor cylinder body; the bending stress of the end plate includes a circumferential bending stress and a radial bending stress; and the membrane stress of the end plate includes a circumferential membrane stress and a radial membrane stress. This step specifically includes the following steps.

Step A: Solve the seven-order matrix equations.

The equation set (18) is solved to obtain seven unknown quantities, i.e., Q₁, Q₂, Q₃, M₁, M₂, M₃ and Vₜ, and then force elements for connection between the four substantial elements are obtained, i.e., Qₜ=Q₁; Q_{g}=−Qₒ=Q₂; Qₛ=Q₃; Q_{d}=Qₜ−Qₛ=Q₁−Q₃; Mₜ=M₁; Mₒ=M_{g}=M₂; Mₛ=M₃; and M_{d}=Mₛ−Mₜ=M₃−M₁. Q₁, Q₂, Q₃, M₁, M₂ and M₃ are introduced, and the following can be obtained from the action relationship between elements: Q₁=Qₜ; Q₂=Q_{g}=−Qₒ; Q₃=Qₛ; Q_{d}=Qₜ−Qₛ=Q₁−Q₃; M₁=Mₜ; M₂=Mₒ=M_{g}; M₃=Mₛ; and M_{d}=Mₛ−Mₜ=M₃−M₁.

Step B: Determine a bending moment and a force of each element in the straight-section external guide cylinder at a connecting joint based on the solution of the seven-order matrix equations, where the solution of the seven-order matrix equations includes the bending moment per unit circumference and the radial force per unit circumference at the connecting joint between the outer cylinder body and the end plate, the bending moment per unit circumference and the radial force per unit circumference at the connecting joint between the end plate and the outer cylinder body, the bending moment per unit circumference and the radial force per unit circumference at the connecting joint between the inner cylinder body and the end plate, the bending moment per unit circumference and the radial force per unit circumference at the connecting joint between the end plate and the inner cylinder body, the bending moment per unit circumference and the radial force per unit circumference at the connecting joint between the internal distributor cylinder body and the end plate, and the unit shear force at the end plate Rt, and the unit shear force acting on the end plate at Rt.

Step C: Calculate the stress of each element in the straight-section external guide cylinder at each position based on the bending moment and the force of the element in the straight-section external guide cylinder at the connecting joint.

A membrane force per unit circumference and a bending moment per unit circumference of each cylinder body along a part (x) in an axial direction, including a circumferential membrane force T_{θ}(x), a circumferential bending moment M_{θ}(x) and a meridional bending moment Mₓ(x), are calculated. According to the classical stress calculation mechanics formula in Appendix A of Chinese standard JB4732-1995 (confirmed in 2005), the bending moment or average membrane force of the inner cylinder body, the outer cylinder body and the internal distributor cylinder body in two directions at different positions (x), i.e., the circumferential membrane force T_{θ}(x), the circumferential bending moment M_{θ}(x) and the meridional bending moment Mₓ(x), can be obtained.

See formula (24) for the formula of the meridional stress of the inner cylinder body at the part x.

$${σ}_{x}^{s} = \frac{{V}_{t}}{{δ}_{s}} ∓ \frac{6 {M}_{x}^{s} ( x )}{{δ}_{s}^{2}} . \qquad ( 24 )$$

Herein, provided are a combination of two stresses: a meridional membrane stress and a meridional bending stress.

See formula (25) for the formula of the circumferential stress of the inner cylinder body.

$${σ}_{θ}^{s} ( x ) = \frac{p {R}_{ms}}{{δ}_{s}} + \frac{{T}_{θ}^{s} ( x )}{{δ}_{s}} ∓ \frac{6 {M}_{θ}^{s} ( x )}{{δ}_{s}^{2}} , \qquad ( 25 )$$

where T_{θ}^{s}(x) is a circumferential membrane force per unit circumference of the inner cylinder body at a distance x from the end portion, in N/mm; and M_{θ}^{s}(x) is the circumferential bending moment per unit circumference of the inner cylinder body at the distance x from the end portion, in MPa/mm.

See formula (26) for the formula of the meridional stress of an outer cylinder body inner shell.

$${σ}_{x}^{g} ( x ) = \frac{{V}_{g}}{{δ}_{g}} ∓ \frac{6 {M}_{x}^{g} ( x )}{{δ}_{g}^{2}} , \qquad ( 26 )$$

where Mₓ^{g}(x) is the meridional bending moment per unit circumference of the outer cylinder body at the distance x from the end portion, in MPa/mm.

See formula (27) for the formula of the circumferential stress of the outer cylinder body inner shell.

$${σ}_{θ}^{g} ( x ) = \frac{p {R}_{m}^{g}}{{δ}_{g}} + \frac{{T}_{θ}^{g} ( x )}{{δ}_{g}} ∓ \frac{6 {M}_{θ}^{g} ( x )}{{δ}_{g}^{2}} , \qquad ( 27 )$$

where T_{θ}^{g}(x) is a circumferential membrane force per unit circumference of the outer cylinder body at the distance x from the end portion, in N/mm; and M_{θ}^{g}(x) is the circumferential bending moment per unit circumference of the outer cylinder body at the distance x from the end portion, in MPa/mm.

See formula (28) for the formula of the meridional stress of the internal distributor cylinder body.

$${σ}_{x}^{d} ( x ) = \frac{{V}_{d}}{{δ}_{d}} ∓ \frac{6 {M}_{x}^{d} ( x )}{{δ}_{d}^{2}} , \qquad ( 28 )$$

where Mₓ^{d}(x) is the meridional bending moment per unit circumference of the internal distributor cylinder body at the distance x from the end portion, in MPa/mm.

See formula (29) for the formula of the circumferential stress of the internal distributor cylinder body.

$${σ}_{θ}^{d} ( x ) = \frac{p {R}_{m}^{d}}{{δ}_{d}} + \frac{{T}_{θ}^{d} ( x )}{{δ}_{d}} ∓ \frac{6 {M}_{θ}^{d} ( x )}{{δ}_{d}^{2}} , \qquad ( 29 )$$

where T_{θ}^{d}(x) is a circumferential membrane force per unit circumference of the internal distributor cylinder body at the distance x from the end portion, in N/mm. M_{θ}^{d}(x) is a circumferential bending moment per unit circumference of the internal distributor cylinder body at the distance x from the end portion, in MPa/mm.

According to the classical stress calculation mechanics formula in Appendix A of Chinese standard JB 4732-1995 (confirmed in 2005), bending moments of the end plate at different radial positions (x) in two directions, i.e., a circumferential bending moment M_{θ}^{E}(x) and a meridional bending moment Mᵣ^{E}(x), can be obtained.

The formula of the radial bending stress of the end plate is obtained from formula (30), and the formula of the circumferential bending stress of the end plate is obtained from formula (31).

$${σ}_{r b} ( x ) = ∓ \frac{6 {M}_{r}^{E} ( x )}{{δ}_{p}^{2}} , and \qquad ( 30 )$$

$${σ}_{θ b} ( x ) = ∓ \frac{6 {M}_{θ}^{E} ( x )}{{δ}_{p}^{2}} , \qquad ( 31 )$$

where Mᵣ^{E}(x) is a radial bending moment per unit circumference of the end plate at a radius r=x, in MPa/mm; and M_{θ}^{E}(x) is a circumferential bending moment per unit circumference of the end plate at the radius r=x, in MPa/mm.

The formula of the radial membrane force of the end plate is obtained from formula (32), and the formula of the circumferential membrane force of the end plate is obtained from formula (33).

$${T}_{r} ( x ) = \frac{- {Q}_{t} \cdot {ρ}_{t}^{2} + {Q}_{o}}{1 - {ρ}_{t}^{2}} - \frac{( {Q}_{o} - {Q}_{t} ) \cdot {ρ}_{t}^{2}}{( 1 - {ρ}_{t}^{2} ) \cdot ( \frac{x}{{R}_{o}} )} . \qquad ( 32 )$$

$${T}_{θ} ( x ) = \frac{- {Q}_{t} \cdot ρ {t}^{2} + {Q}_{o}}{1 - {ρ}_{t}^{2}} + \frac{( {Q}_{o} - {Q}_{t} ) \cdot ρ {t}^{2}}{( 1 - {ρ}_{t}^{2} ) \cdot ( \frac{x}{{R}_{o}} )} . \qquad ( 33 )$$

As shown in FIG. 5, Qₜ is a radial force per unit circumference of the end plate at Rₜ, in N/mm; Qₒ is a radial force per unit circumference of the end plate at Rₒ, in N/mm; Tᵣ(x) is a radial membrane force per unit circumference of the end plate at r=x, in N/mm; and T_{θ}(x) is a circumferential membrane force per unit circumference of the end plate at r=x, in N/mm.

A formula of a radial combined stress of the end plate is obtained from formula (34), and a formula of a circumferential combined stress of the end plate is obtained from formula (35).

$${σ}_{r c} ( x ) = \frac{{T}_{r} ( x )}{{δ}_{p}} + {σ}_{r b} ( x ) , and \qquad ( 34 )$$

$${σ}_{θ c} ( x ) = \frac{{T}_{θ} ( x )}{{δ}_{p}} + {σ}_{θ b} ( x ) , \qquad ( 35 ) ,$$

where σ_{rc}(x) is the radial combined stress of the end plate at r=x, in MPa; and σ_{θc}(x) is the circumferential combined stress of the end plate at r=x, in MPa.

Step 605: Determine a maximum stress of each element in the straight-section external guide cylinder based on the stress at each position of each element in the straight-section external guide cylinder, and perform strength evaluation on the element in the straight-section external guide cylinder based on the maximum stress of each element in the straight-section external guide cylinder, to determine a final wall thickness of each element, where the maximum stress includes a maximum bending stress and a maximum membrane stress.

The circumferential stress and the radial stress at each position of each element, as well as the maximum circumferential stress and the maximum radial stress are obtained based on the above stress calculation formulas.

Safety evaluation is performed on each element of the straight-section external guide cylinder based on the safety evaluation criteria.

An allowable material stress [σ]^{t} and a coefficient ϕ of a welded joint of each element at a design temperature are searched for based on relevant standards (GB/T150 or JB4732, etc.), and stress intensity elevation is performed on related elements. The specific evaluation principles are as follows:

(1) Safety evaluation is performed on the inner cylinder body, the outer cylinder body and the internal distributor cylinder body based on formulas (36)-(39), and it is required to meet formulas (36)-(39) at the same time, otherwise, the thickness of each element is readjusted until the above safety criteria are met. A coefficient ϕ_{L} of a welded joint is a connection coefficient of a circumferential welded joint, and ϕ_{θ} is a connection coefficient of a longitudinal welded joint. The coefficient of the welded joint is selected based on requirements of design standards. When each cylinder body has no circumferential weld, ϕ_{L}=1; and when each cylinder body has no longitudinal weld, ϕ_{θ}=1.

A safety evaluation criterion for a meridional membrane stress of the cylinder body is

$${σ}_{m}^{L} = \frac{{V}_{t}}{{δ}_{s}} \leq {{ϕ}_{L} [ σ ]}^{t} . \qquad ( 36 )$$

A safety evaluation criterion for a circumferential membrane stress of the cylinder body is

$${σ}_{m}^{θ} = \frac{p {R}_{m s}}{{δ}_{s}} \leq {{ϕ}_{θ} [ σ ]}^{t} . \qquad ( 37 )$$

A safety evaluation criterion for a meridional bending stress of the cylinder body is

max(|σₓ+σₘ^{L}|)≤1.5ϕ_{L}[σ]^{t} (38).

A safety evaluation criterion for a circumferential bending stress is

max(|σ_{θ}+σₘ^{θ}|)≤1.5ϕ_{θ}[σ]^{t} (39).

σₘ^{L} is the meridional membrane stress of the cylinder body, and σₘ^{θ} is the circumferential membrane stress of the cylinder body.

(2) Safety Evaluation Criteria for an Annular End Plate

The end plate is evaluated based on formulas (40) and (41), and it is required to meet formulas (40) and (41) at the same time; otherwise, the thickness of each element is readjusted, and recalculation and reevaluation are performed until the above requirements are met.

max(|σ_{rb}(x)|)≤1.5ϕ_{L}^{P}[σ]ₚ^{t} (40); and

max(|θ_{θb}(x)|)≤1.5ϕ_{θ}^{P}[σ]ₚ^{t} (41),

where ϕ_{L}^{P} is a coefficient of a circumferential welded joint of the end plate, and ϕ_{θ}^{P} is a coefficient of a radial welded joint of the cylinder body. The coefficient of the welded joint is selected based on requirements of design standards. When the end plate has no circumferential weld, ϕ_{L}^{P}=1; and when the end plate has no radial weld, ϕ_{θ}^{P}=1.

The wall thickness of the inner cylinder body, the wall thickness of the outer cylinder body, the wall thickness of the end plate and the wall thickness of the internal distributor cylinder body are adjusted based on the above evaluation criteria to obtain the final wall thickness of the inner cylinder body, the final wall thickness of the outer cylinder body, the final wall thickness of the end plate, and the final wall thickness of the internal distributor cylinder body.

### Embodiment 2

This embodiment of the present disclosure provides a correction method for a heat exchanger system, including the following steps.
(1): A safety evaluation method for a straight-section external guide cylinder under an internal pressure load.
(2): Correct the heat exchanger system based on axial stiffness of the straight-section external guide cylinder.
(3): Obtain an axial force of a shell-side cylinder body of a heat exchanger based on the correction and calculation of the heat exchanger system.
(4): Apply the axial force to an end portion of an inner cylinder body of the external guide cylinder, superpose stresses under the internal pressure load and an axial load, and then calculate the strength of the straight-section external guide cylinder under the axial force and the internal pressure load, so as to complete safety evaluation of the straight-section external guide cylinder under the combined action of the internal pressure and the axial force.
(5) Complete the calculation and correction of the entire heat exchanger system after the above calculation and evaluation are completed, otherwise, after the thickness of each related stressed element is adjusted, perform calculation and safety evaluation on the straight-section external guide cylinder and correction of the heat exchanger system again.

The correction method for a heat exchanger system according to this embodiment of the present disclosure further specifically include:
using the safety evaluation method for the straight-section external guide cylinder according to Embodiment 1;
calculating axial stiffness of the straight-section external guide cylinder based on a final wall thickness of each element;
correcting the heat exchanger system based on the axial stiffness of the straight-section external guide cylinder to obtain a correction result of the heat exchanger system, where the correction result of the heat exchanger system includes a tube sheet correction result, a tube bundle correction result, a tube sheet and heat exchange tube joint correction result, and a shell-side cylinder body correction result;
calculating an axial force of a shell-side cylinder body in the heat exchanger system based on the correction result of the shell-side cylinder body, applying the axial force of the shell-side cylinder body to an end portion of the inner cylinder body of the straight-section external guide cylinder, and performing strength calculation together with the medium internal pressure load to update a maximum stress of each element in the straight-section external guide cylinder, where the axial force of the shell-side cylinder body is a calculated axial force load of the straight-section external guide cylinder; and
performing strength evaluation on the element in the straight-section external guide cylinder based on an updated maximum stress of each element in the straight-section external guide cylinder, and updating the final wall thickness of each element.

It is first supposed that a numerical value F=Fs=1 and p=0, parameters such as Mₒ, Mₜ, Vₜ and V_{g} are obtained from the above seven-order matrix equations, then ΔWₛ, ΔW_{g} and ΔWₚ are obtained, and the axial stiffness of the straight-section external guide cylinder is obtained from formula (42).

$$Kac = \frac{2 π \cdot Rms \cdot {F}_{s}}{( Δ {W}_{s} + Δ {W}_{g} + Δ {W}_{p} )} , \qquad ( 42 )$$

$$Δ {W}_{s} = \frac{F \cdot {L}_{s}}{{E}_{s} \cdot ( 2 π \cdot {R}_{ms} \cdot {δ}_{s} )} , Δ {W}_{g} = \frac{{F}_{g} \cdot {L}_{g}}{{E}_{g} \cdot ( 2 π \cdot {R}_{m g} \cdot {δ}_{g} )} = \frac{{Q}_{g} \cdot {L}_{g}}{{E}_{g} \cdot {δ}_{g}} , and$$

$$Δ {W}_{p} = \frac{{R}_{o}^{2}}{{D}_{p}} \cdot ( \frac{- {M}_{o}}{{K}_{VR}} + \frac{{ρ}_{t}}{{K}_{VT}} \cdot {M}_{t} + \frac{{ρ}_{t} \cdot {R}_{o}}{{K}_{VV}} \cdot {V}_{t} ) + \frac{{R}_{o}^{4} \cdot p}{{D}_{p} \cdot {K}_{V p}} ;$$

and where K_{VR}, K_{VT}, K_{VV} and K_{Vp} are calculated according to Appendix A in JB4723-1995.

The correcting the heat exchanger system based on axial stiffness of the straight-section external guide cylinder specifically includes:
correcting and calculating total stiffness of the shell-side cylinder body of a heat exchanger based on the axial stiffness of the straight-section external guide cylinder and stiffness of shell-side residual cylinder body of the heat exchanger;
calculating a thickness of an equivalent cylinder body based on corrected total stiffness of the shell-side cylinder body of the heat exchanger; and
correcting the heat exchanger system based on the thickness of the equivalent cylinder body.

Further, corrected stiffness K′ of the shell-side cylinder body of the heat exchanger is obtained according to formula (43) based on the axial stiffness Kac of the straight-section external guide cylinder and residual stiffness K_{L} of the shell-side cylinder body of the heat exchanger.

The thickness of the equivalent cylinder body is obtained according to formula (44) based on the corrected stiffness K′ of the shell-side cylinder body of the heat exchanger.

The calculation and safety evaluation correction of the heat exchanger system are finally completed based on the thickness of the equivalent cylinder body and a calculation method for segmented cylinder bodies in standards such as GB/T 151.

$$\frac{1}{{K}^{′}} = \frac{1}{K a c} + \frac{1}{{K}_{L}} . \qquad ( 43 )$$

$${δ}_{s}^{′} = \frac{( 0.5 {L}_{g} + {L}_{s} ) \cdot {K}^{′}}{2 \cdot {E}_{s} \cdot π \cdot {R}_{m s}} . \qquad ( 44 )$$

### Embodiment 3

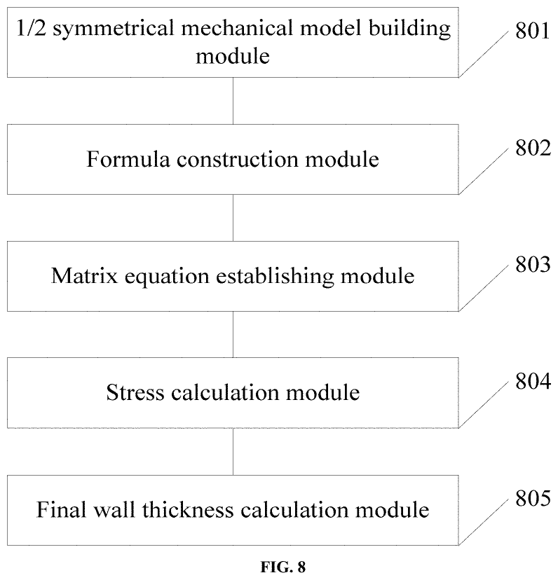

As shown in FIG. 8, this embodiment of the present disclosure is to provide a safety evaluation system for a straight-section external guide cylinder, where the straight-section external guide cylinder is provided with an internal distributor, and includes four elements, namely, an inner cylinder body, an outer cylinder body, an end plate, and an internal distributor cylinder body, and the safety evaluation system for a straight-section external guide cylinder includes:
a ½ symmetrical mechanical model building module 801, configured to establish a ½ symmetrical mechanical model based on symmetrical structural characteristics and real load conditions of the straight-section external guide cylinder, where the ½ symmetrical mechanical model includes an initial wall thickness of the inner cylinder body with an inner diameter of Rᵢ, an initial wall thickness of the outer cylinder body with an inner diameter of Rₒ, an initial wall thickness of the end plate connecting the inner cylinder body to the outer cylinder body, and an initial wall thickness of the internal distributor cylinder body with an inner diameter of Rᵢ; and the real load conditions include a medium internal pressure load and a set axial force load of the straight-section external guide cylinder;
a formula construction module 802, configured to construct a radial displacement formula and a rotation angle formula for each element in the straight-section external guide cylinder based on the ½ symmetrical mechanical model, where the radial displacement formula for each element in the straight-section external guide cylinder includes a radial displacement formula of the inner cylinder body at a connecting joint, a radial displacement formula of the outer cylinder body at a connecting joint, a radial displacement formula of the end plate at Rₜ, a radial displacement formula of the end plate at Rₒ, and a radial displacement formula of the internal distributor cylinder body at a connecting joint; and the rotation angle formula for each element in the straight-section external guide cylinder includes a rotation angle formula of the inner cylinder body at the connecting joint, a rotation angle formula of the outer cylinder body at the connecting joint, a rotation angle formula of the end plate at Rₜ, a rotation angle formula of the end plate at Rₒ, and a rotation angle formula of the internal distributor cylinder body at the connecting joint;
a matrix equation establishing module 803, configured to construct seven-order matrix equations based on the radial displacement formula and the rotation angle formula for each element in the straight-section external guide cylinder, where the seven-order matrix equations represent a deformation coordination relationship and an interaction force relationship among the inner cylinder body, the outer cylinder body, the end plate and the internal distributor cylinder body in the straight-section external guide cylinder;
a stress calculation module 804, configured to calculate a stress at each position of each element in the straight-section external guide cylinder based on a solution of the seven-order matrix equations, where the stress includes a bending stress and a membrane stress of the outer cylinder body, a bending stress and a membrane stress of the end plate, a bending stress and a membrane stress of the inner cylinder body, and a bending stress and a membrane stress of the internal distributor cylinder body; the bending stress of each cylinder body includes a circumferential bending stress and a meridional bending stress; the membrane stress of the cylinder body includes a circumferential membrane stress and a meridional membrane stress; the cylinder body includes the outer cylinder body, the inner cylinder body, and the internal distributor cylinder body; the bending stress of the end plate includes a circumferential bending stress and a radial bending stress; the membrane stress of the end plate includes a circumferential membrane stress and a radial membrane stress; and
a final wall thickness calculation module 805, configured to determine a maximum stress of each element in the straight-section external guide cylinder based on the stress at each position of each element in the straight-section external guide cylinder, and perform strength evaluation on the element in the straight-section external guide cylinder based on the maximum stress of each element in the straight-section external guide cylinder, to determine a final wall thickness of each element, where the maximum stress includes a maximum bending stress and a maximum membrane stress.

$${\sum }_{j = 1}^{7} {F}_{ij} {x}_{j} = {F}_{ip} i = 1 , 2 , … 7$$

The seven-order matrix equations are: {xⱼ}={Q₁,Q₂,Q₃,M₁,M₂,M₃,Vₜ},

where Fᵢⱼ represents a coefficient in each formula, i represents the i^{th} formula, and j represents a coefficient of a j^{th} unknown quantity. For example, F₂₃ represents a coefficient representing the third term in the second formula. Fᵢₚ represents a parameter to the right of the equal sign of the i^{th} formula.

Q₁=Qₜ; Q₂=Q_{g}=−Qₒ; Q₃=Qₛ; Q_{d}=Qₜ−Qₛ=Q₁−Q₃; M₁=Mₜ; M₂=Mₒ=M_{g}; M₃=Mₛ; M_{d}=Mₛ−Mₜ=M₃−M₁; Qₜ is a radial force per unit circumference at a connecting joint Rₜ between the end plate and the inner cylinder body, Q_{g} is a radial force per unit circumference at a connecting joint between the outer cylinder body and the end plate, Qₒ is a radial force per unit circumference at a connecting joint Rₒ between the end plate and the outer cylinder body, Qₛ is a radial force per unit circumference at a connecting joint between the inner cylinder body and the end plate, and Q_{d} is a radial force per unit circumference at a connecting joint between the internal distributor cylinder body and the end plate; Mₜ is a bending moment per unit circumference at the connecting joint Rₜ between the end plate and the inner cylinder body, Mₒ is a bending moment per unit circumference at the connecting joint Rₒ between the end plate and the outer cylinder body, M_{g} is a bending moment per unit circumference at the connecting joint between the outer cylinder body and the end plate, Mₛ is a bending moment per unit circumference at the connecting joint between the inner cylinder body and the end plate, and M_{d} is a bending moment per unit circumference at the connecting joint between the internal distributor cylinder body and the end plate; and Vₜ is a unit shear force acting on the end plate at Rₜ;

when i=1 and Dₛ=Dₜ, the following formula is obtained:

$$( \frac{{ρ}_{t} \cdot {R}_{o}}{{E}_{p} \cdot {δ}_{p}} ( \frac{1 + {ρ}_{t}^{2}}{1 - {ρ}_{t}^{2}} + {ν}_{p} ) ) {Q}_{1} + \frac{2 \cdot {ρ}_{t} \cdot {R}_{o}}{{E}_{p} \cdot {δ}_{p} \cdot ( 1 - {ρ}_{t}^{2} )} {Q}_{2} + \frac{2 {k}_{s} \cdot {R}_{ms}^{2}}{{E}_{s} \cdot {δ}_{s}} {Q}_{3} + \frac{2 {k}_{s}^{2} \cdot {R}_{ms}^{2}}{{E}_{s} \cdot {δ}_{s}} {M}_{3} = - \frac{{R}_{ms}^{2}}{{E}_{s} \cdot {δ}_{s}} ( 1 - 0.5 {ν}_{s} ) \cdot p ,$$

where Dₛ is radial displacement of the inner cylinder body at the connecting joint, and Dₜ is radial displacement of the end plate at Rₜ; ρₜ=Rₜ/Rₒ; Eₚ is an elastic modulus of the end plate material, in MPa; δₚ is the initial wall thickness of the end plate; vₚ is a Poisson's ratio of the end plate material; kₛ is a coefficient of the inner cylinder body shell; Rₘₛ is a middle plane radius of the inner cylinder body shell, in mm, and Rₘₛ=Rᵢ+0.5δₛ; δₛ is the initial wall thickness of the inner cylinder body; Eₛ is an elastic modulus of the inner cylinder body material, in MPa; and p is an internal pressure;

when i=2 and Dₛ=D_{d}, the following formula is obtained:

$$- \frac{2 {k}_{d} \cdot {{R}_{md}}^{2}}{{E}_{d} \cdot {δ}_{d}} {Q}_{1} + ( \frac{2 {k}_{s} \cdot {{R}_{ms}}^{2}}{Es \cdot δ s} + \frac{2 {k}_{d} \cdot {{R}_{md}}^{2}}{{E}_{d} \cdot {δ}_{d}} ) {Q}_{3} + \frac{2 {{k}_{d}}^{2} \cdot {{R}_{md}}^{2}}{{E}_{d} \cdot {δ}_{d}} {M}_{1} + ( \frac{2 {{k}_{s}}^{2} \cdot {{R}_{ms}}^{2}}{Es \cdot δ s} - \frac{2 {{k}_{d}}^{2} \cdot {{R}_{md}}^{2}}{{E}_{d} \cdot {δ}_{d}} ) {M}_{3} = - \frac{{{R}_{ms}}^{2}}{Es \cdot δ s} ( 1 - 0.5 {v}_{s} ) \cdot p ,$$

where D_{d} is radial displacement of the internal distributor cylinder body at the connecting joint; E_{d} is an elastic modulus of the internal distributor cylinder body material, in MPa; R_{md} is a middle plane radius of an internal distributor cylinder body shell, in mm, and R_{md}=Rᵢ+0.5δ_{d}; δ_{d} is the initial wall thickness of the internal distributor cylinder body; and k_{d} is a coefficient of the internal distributor cylinder body shell;

when i=3 and Dₒ=D_{g}, the following formula is obtained:

$$- \frac{2 \cdot {R}_{o} \cdot {{ρ}_{t}}^{2}}{{E}_{p} \cdot {δ}_{p} \cdot ( 1 - {{ρ}_{t}}^{2} )} {Q}_{1} - ( \frac{{R}_{o}}{{E}_{p} \cdot {δ}_{p}} ( \frac{1 + {{ρ}_{t}}^{2}}{1 - {{ρ}_{t}}^{2}} - {v}_{p} ) + \frac{2 {k}_{g} \cdot {{R}_{m g}}^{2}}{{E}_{g} \cdot {δ}_{g}} ) {Q}_{2} - \frac{2 {{k}_{g}}^{2} \cdot {{R}_{m g}}^{2}}{{E}_{g} \cdot {δ}_{g}} {M}_{2} = \frac{{{R}_{m g}}^{2}}{{E}_{g} \cdot {δ}_{g}} ( 1 - 0.5 {v}_{g} ) \cdot p ,$$

where Dₒ is radial displacement of the end plate at Rₒ; D_{g} is radial displacement of the outer cylinder body at the connecting joint; E_{g} is an elastic modulus of the outer cylinder body material, in MPa; R_{mg} is a middle plane radius of an outer cylinder body shell, in mm, and R_{mg}=Rₒ+0.5δ_{g}; δ_{g} is the initial wall thickness of the outer cylinder body; and v_{g} is a Poisson's ratio of the outer cylinder body material;

when i=4 and βₛ=βₜ, the following formula is obtained:

$$\frac{2 {{k}_{s}}^{2} \cdot {{R}_{m s}}^{2}}{{E}_{s} \cdot {δ}_{s}} {Q}_{3} + \frac{{R}_{o} \cdot {ρ}_{t}}{{D}_{p} \cdot {K}_{tt}} {M}_{1} - \frac{{R}_{o}}{{D}_{p} \cdot {K}_{tR}} {M}_{2} + \frac{4 {{k}_{s}}^{3} \cdot {{R}_{m s}}^{2}}{{E}_{s} \cdot {δ}_{s}} {M}_{3} + \frac{{{R}_{o}}^{2} \cdot {ρ}_{t}}{{D}_{p} \cdot {K}_{tV}} {V}_{t} = - \frac{{{R}_{o}}^{3}}{{D}_{p} \cdot {K}_{tp}} p ,$$

where βₛ is a rotation angle of the inner cylinder body at the connecting joint, βₜ is a rotation angle of the end plate at Rₜ, and K_{tR}, Kₜₜ, K_{tV}, Kₜₚ and Dₚ are all end plate calculation coefficients, and are related to geometric dimensions of the end plate;

when i=5 and βₛ=−β_{d}, the following formula is obtained.

$$\frac{2 {{k}_{d}}^{2} \cdot {{R}_{m d}}^{2}}{{E}_{d} \cdot {δ}_{d}} {Q}_{1} + ( \frac{2 {{k}_{s}}^{2} \cdot {{R}_{m s}}^{2}}{{E}_{s} \cdot {δ}_{s}} - \frac{2 {{k}_{d}}^{2} \cdot {{R}_{m d}}^{2}}{{E}_{d} \cdot {δ}_{d}} ) {Q}_{3} - \frac{4 {{k}_{d}}^{3} \cdot {{R}_{m d}}^{2}}{{E}_{d} \cdot {δ}_{d}} {M}_{1} + ( \frac{4 {{k}_{s}}^{3} \cdot {{R}_{m s}}^{2}}{{E}_{s} \cdot {δ}_{s}} + \frac{4 {{k}_{d}}^{3} \cdot {{R}_{m d}}^{2}}{{E}_{d} \cdot {δ}_{d}} ) {M}_{3} = 0 ,$$

where β_{d} is a rotation angle of the internal distributor cylinder body at the connecting joint;

when i=6 and βₒ=β_{g}, the following formula is obtained:

$$- \frac{2 {{k}_{g}}^{2} \cdot {{R}_{mg}}^{2}}{{E}_{g} \cdot {δ}_{g}} {Q}_{2} + \frac{{R}_{o} \cdot {ρ}_{t}}{{D}_{p} \cdot {K}_{Rt}} {M}_{1} - ( \frac{{R}_{o}}{{D}_{p} \cdot {K}_{RR}} + \frac{4 {{k}_{g}}^{3} \cdot {{R}_{mg}}^{2}}{{E}_{g} \cdot {δ}_{g}} ) {M}_{2} + \frac{{{R}_{o}}^{2} \cdot {ρ}_{t}}{{D}_{p} \cdot {K}_{R V}} {V}_{t} = - \frac{{{R}_{o}}^{3}}{{D}_{p} \cdot {K}_{Rp}} p ,$$

where βₒ is a rotation angle of the end plate at Rₒ, and K_{RR}, K_{Rt}, K_{RV}, and K_{Rp} are all end plate calculation coefficients, and are related to geometric dimensions of the end plate; and β_{g} is a rotation angle of the outer cylinder body at the connecting joint; and

when i=7 and W_{d}=W_{g}+ΔWₚ, the following formula is obtained:

$$\frac{{R}_{o}^{2}}{{D}_{p}} \frac{{ρ}_{t}}{{K}_{VT}} \cdot {M}_{1} - \frac{{R}_{o}^{2}}{{D}_{p}} \cdot \frac{1}{{K}_{VR}} \cdot {M}_{2} + ( \frac{{L}_{g} \cdot {ρ}_{t}}{2 \cdot {E}_{g} \cdot {δ}_{g}} + \frac{{ρ}_{t} \cdot {R}_{o}^{3}}{{D}_{p} \cdot {K}_{VV}} + \frac{{L}_{g} + ( \frac{1}{ϕ} - 1 ) {L}_{belt}}{2 \cdot {E}_{d} \cdot {δ}_{d}} ) \cdot {V}_{t} = \frac{F}{2 \cdot {E}_{d} \cdot {δ}_{d}} \cdot [ {L}_{g} + ( \frac{1}{ϕ} - 1 ) {L}_{b e l t} ] - \frac{{L}_{g} \cdot p}{2 \cdot {E}_{g} \cdot {δ}_{g}} \cdot ( 0.5 \cdot {R}_{o} ( 1 - {{ρ}_{t}}^{2} ) - {R}_{mg} \cdot {v}_{g} ) - \frac{{R}_{o}^{4} \cdot p}{{D}_{p} \cdot {K}_{Vp}} ,$$

where W_{d} is axial displacement of an end portion of the internal distributor cylinder body, in mm; W_{g} is axial displacement of an end portion of the outer cylinder body, in mm; and ΔWp is an axial displacement difference at an inner/outer radius of the end plate, in mm.

### Embodiment 4

This embodiment of the present disclosure provides a correction system for a heat exchanger system, including:
a safety evaluation system for a straight-section external guide cylinder, where the safety evaluation system for a straight-section external guide cylinder is a system determined by means of the safety evaluation method for the straight-section external guide cylinder according to Embodiment 1;
an axial stiffness calculation module, configured to calculate axial stiffness of the straight-section external guide cylinder based on a final wall thickness of each element;
a heat exchanger system correction module, configured to correct the heat exchanger system based on the axial stiffness of the straight-section external guide cylinder to obtain a correction result of the heat exchanger system, where the correction result of the heat exchanger system includes a tube sheet correction result, a tube bundle correction result, a tube sheet and heat exchange tube joint correction result, and a shell-side cylinder body correction result;
a maximum stress update module, configured to calculate an axial force of a shell-side cylinder body in the heat exchanger system based on the correction result of the shell-side cylinder body, apply the axial force of the shell-side cylinder body to an end portion of the inner cylinder body of the straight-section external guide cylinder, and perform strength calculation together with the medium internal pressure load to update a maximum stress of each element in the straight-section external guide cylinder, where the axial force of the shell-side cylinder body is a calculated axial force load of the straight-section external guide cylinder; and
a final wall thickness update module, configured to perform strength evaluation on the element in the straight-section external guide cylinder based on an updated maximum stress of each element in the straight-section external guide cylinder, and update the final wall thickness of each element.

The heat exchanger system correction module specifically includes:
a shell-side cylinder body total stiffness correction unit, configured to correct and calculate total stiffness of the shell-side cylinder body of a heat exchanger based on the axial stiffness of the straight-section external guide cylinder and stiffness of shell-side residual cylinder body of the heat exchanger; an equivalent cylinder body thickness calculation unit, configured to calculate a thickness of an equivalent cylinder body based on corrected total stiffness of the shell-side cylinder body of the heat exchanger; and a heat exchanger system correction unit, configured to correct the heat exchanger system based on the thickness of the equivalent cylinder body.

The axial force of the equivalent cylinder body can be obtained by the correction and calculation of the heat exchanger system, and an axial load F of the straight-section external guide cylinder is calculated based on the axial force. The stress of the straight-section external guide cylinder under the combined action of the internal pressure and the axial force is further calculated based on the above seven-order matrix equations. After the safety evaluation is passed, the wall thickness is considered to be qualified. Otherwise, the wall thickness of each corresponding element of the straight-section external guide cylinder is adjusted, and design and calculation are performed again.

The present disclosure has the following innovation points:
(1) A method for calculating a force and a bending moment at an edge of each element of the straight-section external guide cylinder with the internal distributor under the internal pressure and the axial force load based on the mechanical model of the analytical solution of the theory of plates and shells, mathematical calculation and derivation, the established equation set, as well as a deformation coordination relationship and an axial mechanical balance relationship;
(2) a method for calculating stresses of four elements of the straight-section external guide cylinder with the internal distributor in two directions;
(3) a method for calculating axial stiffness of the straight-section external guide cylinder with the internal distributor; and
(4) a calculation and correction method for a fixed tube-sheet heat exchanger with the straight-section external guide cylinder provided with the internal distributor.

Embodiments of the description are described in a progressive manner, each embodiment focuses on the difference from other embodiments, and for the same and similar parts between the embodiments, reference may be made to each other. Since the system disclosed in an embodiment corresponds to the method disclosed in another embodiment, the description is relatively simple, and for related parts, reference may be made to the method description.

Specific examples are used herein to explain the principles and implementations of the present disclosure. The foregoing description of the embodiments is merely intended to help understand the method of the present disclosure and its core ideas; besides, various modifications may be made by a person of ordinary skill in the art to specific implementations and the scope of application in accordance with the ideas of the present disclosure. In conclusion, the content of the description shall not be construed as limitations to the present disclosure.

1-10. (canceled)

11. A safety evaluation method for a straight-section external guide cylinder, wherein the straight-section external guide cylinder is provided with an internal distributor, and comprises four elements, namely, an inner cylinder body, an outer cylinder body, an end plate, and an internal distributor cylinder body, and the safety evaluation method for the straight-section external guide cylinder comprises:
establishing a ½ symmetrical mechanical model based on symmetrical structural characteristics and real load conditions of the straight-section external guide cylinder, wherein the ½ symmetrical mechanical model comprises an initial wall thickness of the inner cylinder body with an inner diameter of Rᵢ, an initial wall thickness of the outer cylinder body with an inner diameter of Rₒ, an initial wall thickness of the end plate connecting the inner cylinder body to the outer cylinder body, and an initial wall thickness of the internal distributor cylinder body with an inner diameter of Rᵢ; and the real load conditions comprise a medium internal pressure load and a set axial force load of the straight-section external guide cylinder;
constructing a radial displacement formula and a rotation angle formula for each element in the straight-section external guide cylinder based on the ½ symmetrical mechanical model, wherein the radial displacement formula for each element in the straight-section external guide cylinder comprises a radial displacement formula of the inner cylinder body at a connecting joint, a radial displacement formula of the outer cylinder body at a connecting joint, a radial displacement formula of the end plate at Rₜ, a radial displacement formula of the end plate at Rₒ, and a radial displacement formula of the internal distributor cylinder body at a connecting joint; and the rotation angle formula for each element in the straight-section external guide cylinder comprises a rotation angle formula of the inner cylinder body at the connecting joint, a rotation angle formula of the outer cylinder body at the connecting joint, a rotation angle formula of the end plate at Rₜ, a rotation angle formula of the end plate at Rₒ, and a rotation angle formula of the internal distributor cylinder body at the connecting joint;
constructing seven-order matrix equations based on the radial displacement formula and the rotation angle formula for each element in the straight-section external guide cylinder, wherein the seven-order matrix equations represent a deformation coordination relationship and an interaction force relationship among the inner cylinder body, the outer cylinder body, the end plate and the internal distributor cylinder body in the straight-section external guide cylinder;
calculating a stress at each position of each element in the straight-section external guide cylinder based on a solution of the seven-order matrix equations, wherein the stress comprises a bending stress and a membrane stress of the outer cylinder body, a bending stress and a membrane stress of the end plate, a bending stress and a membrane stress of the inner cylinder body, and a bending stress and a membrane stress of the internal distributor cylinder body; the bending stress of each cylinder body comprises a circumferential bending stress and a meridional bending stress; the membrane stress of the cylinder body comprises a circumferential membrane stress and a meridional membrane stress; the cylinder body comprises the outer cylinder body, the inner cylinder body, and the internal distributor cylinder body; the bending stress of the end plate comprises a circumferential bending stress and a radial bending stress; the membrane stress of the end plate comprises a circumferential membrane stress and a radial membrane stress; and
determining a maximum stress of each element in the straight-section external guide cylinder based on the stress at each position of each element in the straight-section external guide cylinder, and performing strength evaluation on the element in the straight-section external guide cylinder based on the maximum stress of each element in the straight-section external guide cylinder, to determine a final wall thickness of each element, wherein the maximum stress comprises a maximum bending stress and a maximum membrane stress.

12. The safety evaluation method for the straight-section external guide cylinder according to claim 11, wherein the establishing a ½ symmetrical mechanical model based on symmetrical structural characteristics and real load conditions of the straight-section external guide cylinder specifically comprises:
calculating the initial wall thickness of the inner cylinder body, the initial wall thickness of the outer cylinder body, the initial wall thickness of the end plate, and the initial wall thickness of the internal distributor cylinder body by means of a semi-empirical method based on design conditions of the straight-section external guide cylinder; and
establishing the ½ symmetrical mechanical model based on the symmetrical structural characteristics of the straight-section external guide cylinder, the initial wall thickness of the inner cylinder body, the initial wall thickness of the outer cylinder body, the initial wall thickness of the end plate, and the initial wall thickness of the internal distributor cylinder body.

13. The safety evaluation method for the straight-section external guide cylinder according to claim 11, wherein the seven-order matrix equations are:
$${\sum }_{j = 1}^{7} {F}_{ij} {x}_{j} = {F}_{ip}$$
$$i = 1 , 2 , … 7$$
$$\{ {x}_{j} \} = \{ {Q}_{1} , {Q}_{2} , {Q}_{3} , {M}_{1} , {M}_{2} , {M}_{3} , {V}_{t} \} ,$$
wherein Q₁=Qₜ; Q₂=Q_{g}=−Qₒ; Q₃=Qₛ; Q_{d}=Qₜ−Qₛ=Q₁−Q₃; M₁=Mₜ; M₂=Mₒ=M_{g}; M₃=Mₛ; M_{d}=Mₛ−Mₜ=M₃−M₁; Qₜ is a radial force per unit circumference at a connecting joint Rₜ between the end plate and the inner cylinder body, Q_{g} is a radial force per unit circumference at a connecting joint between the outer cylinder body and the end plate, Qₒ is a radial force per unit circumference at a connecting joint Rₒ between the end plate and the outer cylinder body, Qₛ is a radial force per unit circumference at a connecting joint between the inner cylinder body and the end plate, and Q_{d} is a radial force per unit circumference at a connecting joint between the internal distributor cylinder body and the end plate; Mₜ is a bending moment per unit circumference at the connecting joint Rₜ between the end plate and the inner cylinder body, Mₒ is a bending moment per unit circumference at the connecting joint Rₒ between the end plate and the outer cylinder body, M_{g} is a bending moment per unit circumference at the connecting joint between the outer cylinder body and the end plate, Mₛ is a bending moment per unit circumference at the connecting joint between the inner cylinder body and the end plate, and M_{d} is a bending moment per unit circumference at the connecting joint between the internal distributor cylinder body and the end plate; and Vₜ is a unit shear force acting on the end plate at Rₜ;
when i=1 and Dₛ=Dₜ the following formula is obtained:
$$( \frac{{ρ}_{t} \cdot {R}_{o}}{{E}_{p} \cdot {δ}_{p}} ( \frac{1 + {{ρ}_{t}}^{2}}{1 - {{ρ}_{t}}^{2}} + {v}_{p} ) ) {Q}_{1} + \frac{2 \cdot {ρ}_{t} \cdot {R}_{o}}{{E}_{p} \cdot {δ}_{p} \cdot ( 1 - {{ρ}_{t}}^{2} )} {Q}_{2} + \frac{2 {k}_{s} \cdot {{R}_{ms}}^{2}}{{E}_{s} \cdot {δ}_{s}} {Q}_{3} + \frac{2 {{k}_{s}}^{2} \cdot {{R}_{ms}}^{2}}{{E}_{s} \cdot {δ}_{s}} {M}_{3} = - \frac{{{R}_{ms}}^{2}}{{E}_{s} \cdot {δ}_{s}} ( 1 - 0.5 {v}_{s} ) \cdot p ,$$
wherein Dₛ is radial displacement of the inner cylinder body at the connecting joint, and Dₜ is radial displacement of the end plate at Rₜ; ρₜ=Rₜ/Rₒ; Eₚ is an elastic modulus of the end plate material, in MPa; δₚ is the initial wall thickness of the end plate; vₚ is a Poisson's ratio of the end plate material; kₛ is a coefficient of the inner cylinder body shell; Rₘₛ is a middle plane radius of the inner cylinder body shell, in mm, and Rₘₛ=Rₜ+0.5δₛ; δₛ is the initial wall thickness of the inner cylinder body; Eₛ is an elastic modulus of the inner cylinder body material, in MPa; and p is an internal pressure;
when i=2 and Dₛ=D_{d}, the following formula is obtained:
$$- \frac{2 {k}_{d} \cdot {{R}_{md}}^{2}}{{E}_{d} \cdot {δ}_{d}} {Q}_{1} + ( \frac{2 {k}_{s} \cdot {{R}_{ms}}^{2}}{Es \cdot δ s} + \frac{2 {k}_{d} \cdot {{R}_{md}}^{2}}{{E}_{d} \cdot {δ}_{d}} ) {Q}_{3} + \frac{2 {{k}_{d}}^{2} \cdot {{R}_{md}}^{2}}{{E}_{d} \cdot {δ}_{d}} {M}_{1} + ( \frac{2 {{k}_{s}}^{2} \cdot {{R}_{ms}}^{2}}{Es \cdot δ s} - \frac{2 {{k}_{d}}^{2} \cdot {{R}_{md}}^{2}}{{E}_{d} \cdot {δ}_{d}} ) {M}_{3} = - \frac{{{R}_{ms}}^{2}}{Es \cdot δ s} ( 1 - 0.5 {v}_{s} ) \cdot p ,$$
wherein D_{d} is radial displacement of the internal distributor cylinder body at the connecting joint; E_{d} is an elastic modulus of the internal distributor cylinder body material, in MPa; R_{md} is a middle plane radius of an internal distributor cylinder body shell, in mm, and R_{md}=Rₜ+0.5δ_{d}; δ_{d} is the initial wall thickness of the internal distributor cylinder body; and k_{d} is a coefficient of the internal distributor cylinder body shell;
when i=3 and Dₒ=D_{g}, the following formula is obtained:
$$- \frac{2 \cdot {R}_{o} \cdot {{ρ}_{t}}^{2}}{{E}_{p} \cdot {δ}_{p} \cdot ( 1 - {{ρ}_{t}}^{2} )} {Q}_{1} - ( \frac{{R}_{o}}{{E}_{p} \cdot {δ}_{p}} ( \frac{1 + {{ρ}_{t}}^{2}}{1 - {{ρ}_{t}}^{2}} - {ν}_{p} ) + \frac{2 {k}_{g} \cdot {{R}_{mg}}^{2}}{{E}_{g} \cdot {δ}_{g}} ) {Q}_{2} - \frac{2 {{k}_{g}}^{2} \cdot {{R}_{mg}}^{2}}{{E}_{g} \cdot {δ}_{g}} {M}_{2} = \frac{{{R}_{mg}}^{2}}{{E}_{g} \cdot {δ}_{g}} ( 1 - 0.5 {ν}_{g} ) \cdot p ,$$
wherein Dₒ is radial displacement of the end plate at Rₒ; D_{g} is radial displacement of the outer cylinder body at the connecting joint; E_{g} is an elastic modulus of the outer cylinder body material, in MPa; R_{mg} is a middle plane radius of an outer cylinder body shell, in mm, and R_{mg}=Rₒ+0.5δ_{g}; δ_{g} is the initial wall thickness of the outer cylinder body; and v_{g} is a Poisson's ratio of the outer cylinder body material;
when i=4 and βₛ=βₜ, the following formula is obtained:
$$\frac{2 {{k}_{s}}^{2} \cdot {{R}_{m s}}^{2}}{{E}_{s} \cdot {δ}_{s}} {Q}_{3} + \frac{{R}_{o} \cdot {ρ}_{t}}{{D}_{p} \cdot {K}_{t t}} {M}_{1} - \frac{{R}_{o}}{{D}_{p} \cdot {K}_{tR}} {M}_{2} + \frac{4 {{k}_{s}}^{3} \cdot {{R}_{m s}}^{2}}{{E}_{s} \cdot {δ}_{s}} {M}_{3} + \frac{{{R}_{o}}^{2} \cdot {ρ}_{t}}{{D}_{p} \cdot {K}_{tV}} {V}_{t} = - \frac{{{R}_{o}}^{3}}{{D}_{p} \cdot {K}_{tp}} p ,$$
wherein βₛ is a rotation angle of the inner cylinder body at the connecting joint, βₜ is a rotation angle of the end plate at Rₜ, and K_{tR}, Kₜₜ, K_{tV}, Kₜₚ and Dₚ are all end plate calculation coefficients, and are related to geometric dimensions of the end plate;
when i=5 and βₛ=−β_{d}, the following formula is obtained:
$$\frac{2 {k}_{d}^{2} \cdot {{R}_{m d}}^{2}}{{E}_{d} \cdot {δ}_{d}} {Q}_{1} + ( \frac{2 {k}_{s}^{2} \cdot {{R}_{m s}}^{2}}{{E}_{s} \cdot {δ}_{s}} - \frac{2 {k}_{d}^{2} \cdot {{R}_{m d}}^{2}}{{E}_{d} \cdot {δ}_{d}} ) {Q}_{3} - \frac{4 {k}_{d}^{3} \cdot {{R}_{m d}}^{2}}{{E}_{d} \cdot {δ}_{d}} {M}_{1} + ( \frac{4 {k}_{s}^{3} \cdot {{R}_{m s}}^{2}}{{E}_{s} \cdot {δ}_{s}} + \frac{4 {k}_{d}^{3} \cdot {{R}_{m d}}^{2}}{{E}_{d} \cdot {δ}_{d}} ) {M}_{3} = 0 ,$$
wherein β_{d} is a rotation angle of the internal distributor cylinder body at the connecting joint;
when i=6 and βₒ=β_{g}, the following formula is obtained:
$$- \frac{2 {k}_{g}^{2} \cdot {{R}_{m g}}^{2}}{{E}_{g} \cdot {δ}_{g}} {Q}_{2} + \frac{{R}_{o} \cdot {ρ}_{t}}{{D}_{p} \cdot {K}_{Rt}} {M}_{1} - ( \frac{{R}_{o}}{{D}_{p} \cdot {K}_{RR}} + \frac{4 {k}_{g}^{3} \cdot {{R}_{m g}}^{2}}{{E}_{g} \cdot {δ}_{g}} ) {M}_{2} + \frac{{{R}_{o}}^{2} \cdot {ρ}_{t}}{{D}_{p} \cdot {K}_{R V}} {V}_{t} = - \frac{{{R}_{o}}^{3}}{{D}_{p} \cdot {K}_{Rp}} p ,$$
wherein βₒ is a rotation angle of the end plate at Rₒ, and K_{RR}, K_{Rt}, K_{RV} and K_{Rp} are all end plate calculation coefficients, and are related to geometric dimensions of the end plate; and β_{g} is a rotation angle of the outer cylinder body at the connecting joint; and
when i=7 and W_{d}=W_{g}+ΔWₚ, the following formula is obtained:
$$\frac{{R}_{o}^{2}}{{D}_{p}} \frac{{ρ}_{t}}{{K}_{VT}} \cdot {M}_{1} - \frac{{R}_{o}^{2}}{{D}_{p}} \cdot \frac{1}{{K}_{VR}} \cdot {M}_{2} + ( \frac{{L}_{g} \cdot {ρ}_{t}}{2 \cdot {E}_{g} \cdot {δ}_{g}} + \frac{{ρ}_{t} \cdot {R}_{o}^{3}}{{D}_{p} \cdot {K}_{VV}} + \frac{{L}_{g} + ( \frac{1}{ϕ} - 1 ) {L}_{belt}}{2 \cdot {E}_{d} \cdot {δ}_{d}} ) \cdot {V}_{t} = \frac{F}{2 \cdot {E}_{d} \cdot {δ}_{d}} \cdot [ {L}_{g} + ( \frac{1}{ϕ} - 1 ) {L}_{belt} ] - \frac{{L}_{g} \cdot p}{2 \cdot {E}_{g} \cdot {δ}_{g}} \cdot ( 0.5 \cdot {R}_{o} ( 1 - {{ρ}_{t}}^{2} ) - {R}_{m g} \cdot {v}_{g} ) - \frac{{R}_{o}^{4} \cdot p}{{D}_{p} \cdot {K}_{Vp}} ,$$
wherein W_{d} is axial displacement of an end portion of the internal distributor cylinder body, in mm; W_{g} is axial displacement of an end portion of the outer cylinder body, in mm; and ΔWₚ is an axial displacement difference at an inner/outer radius of the end plate, in mm.

14. The safety evaluation method for the straight-section external guide cylinder according to claim 11, wherein the calculating a stress at each position of each element in the straight-section external guide cylinder based on a solution of the seven-order matrix equations specifically comprises:
solving the seven-order matrix equations;
determining a bending moment and a force of each element in the straight-section external guide cylinder at a connecting joint based on the solution of the seven-order matrix equations, wherein the solution of the seven-order matrix equations comprises the bending moment per unit circumference and the radial force per unit circumference at the connecting joint between the outer cylinder body and the end plate, the bending moment per unit circumference and the radial force per unit circumference at the connecting joint between the end plate and the outer cylinder body, the bending moment per unit circumference and the radial force per unit circumference at the connecting joint between the inner cylinder body and the end plate, the bending moment per unit circumference and the radial force per unit circumference at the connecting joint between the end plate and the inner cylinder body, the bending moment per unit circumference and the radial force per unit circumference at the connecting joint between the internal distributor cylinder body and the end plate, and the unit shear force at the end plate Rₜ, and the unit shear force acting on the end plate at Rₜ; and
calculating the stress of each element in the straight-section external guide cylinder at each position based on the bending moment and the force of the element in the straight-section external guide cylinder at the connecting joint.

15. A correction method for a heat exchanger system, comprising:
using the safety evaluation method for the straight-section external guide cylinder according to claim 11;
calculating axial stiffness of the straight-section external guide cylinder based on a final wall thickness of each element;
correcting the heat exchanger system based on the axial stiffness of the straight-section external guide cylinder to obtain a correction result of the heat exchanger system, wherein the correction result of the heat exchanger system comprises a tube sheet correction result, a tube bundle correction result, a tube sheet and heat exchange tube joint correction result, and a shell-side cylinder body correction result;
calculating an axial force of a shell-side cylinder body in the heat exchanger system based on the correction result of the shell-side cylinder body, applying the axial force of the shell-side cylinder body to an end portion of the inner cylinder body of the straight-section external guide cylinder, and performing strength calculation together with the medium internal pressure load to update a maximum stress of each element in the straight-section external guide cylinder, wherein the axial force of the shell-side cylinder body is a calculated axial force load of the straight-section external guide cylinder; and
performing strength evaluation on the element in the straight-section external guide cylinder based on an updated maximum stress of each element in the straight-section external guide cylinder, and updating the final wall thickness of each element.

16. The correction method for a heat exchanger system according to claim 15, wherein the establishing a ½ symmetrical mechanical model based on symmetrical structural characteristics and real load conditions of the straight-section external guide cylinder specifically comprises:
calculating the initial wall thickness of the inner cylinder body, the initial wall thickness of the outer cylinder body, the initial wall thickness of the end plate, and the initial wall thickness of the internal distributor cylinder body by means of a semi-empirical method based on design conditions of the straight-section external guide cylinder; and
establishing the ½ symmetrical mechanical model based on the symmetrical structural characteristics of the straight-section external guide cylinder, the initial wall thickness of the inner cylinder body, the initial wall thickness of the outer cylinder body, the initial wall thickness of the end plate, and the initial wall thickness of the internal distributor cylinder body.

17. The correction method for a heat exchanger system according to claim 15, wherein the
$${\sum }_{j = 1}^{7} {F}_{ij} {x}_{j} = {F}_{ip}$$
$$i = 1 , 2 , … 7$$
seven-order matrix equations are: {xⱼ}={Q₁,Q₂,Q₃,M₁,M₂,M₃,Vₜ},
wherein Q₁=Qₜ; Q₂=Q_{g}=−Qₒ; Q₃=Qₛ; Q_{d}=Qₜ−Qₛ=Q₁−Q₃; M₁=Mₜ; M₂=Mₒ=M_{g}; M₃=Mₛ; M_{d}=Mₛ−Mₜ=M₃−M₁; Qₜ is a radial force per unit circumference at a connecting joint Rₜ between the end plate and the inner cylinder body, Q_{g} is a radial force per unit circumference at a connecting joint between the outer cylinder body and the end plate, Qₒ is a radial force per unit circumference at a connecting joint Rₒ between the end plate and the outer cylinder body, Qₛ is a radial force per unit circumference at a connecting joint between the inner cylinder body and the end plate, and Q_{d} is a radial force per unit circumference at a connecting joint between the internal distributor cylinder body and the end plate; Mₜ is a bending moment per unit circumference at the connecting joint Rₜ between the end plate and the inner cylinder body, Mₒ is a bending moment per unit circumference at the connecting joint Rₒ between the end plate and the outer cylinder body, M_{g} is a bending moment per unit circumference at the connecting joint between the outer cylinder body and the end plate, Mₛ is a bending moment per unit circumference at the connecting joint between the inner cylinder body and the end plate, and M_{d} is a bending moment per unit circumference at the connecting joint between the internal distributor cylinder body and the end plate; and Vₜ is a unit shear force acting on the end plate at Rₜ;
when i=1 and Dₛ=Dₜ, the following formula is obtained:
$$( \frac{{ρ}_{t} \cdot {R}_{o}}{{E}_{p} \cdot {δ}_{p}} ( \frac{1 + {ρ}_{t}^{2}}{1 - {ρ}_{t}^{2}} + {v}_{p} ) ) {Q}_{1} + \frac{2 \cdot {ρ}_{t} \cdot {R}_{o}}{{E}_{p} \cdot {δ}_{p} \cdot ( 1 - {ρ}_{t}^{2} )} {Q}_{2} + \frac{2 {k}_{s} \cdot {R}_{ms}^{2}}{{E}_{s} \cdot {δ}_{s}} {Q}_{3} + \frac{2 {k}_{s}^{2} \cdot {R}_{ms}^{2}}{{E}_{s} \cdot {δ}_{s}} {M}_{3} = - \frac{{R}_{ms}^{2}}{{E}_{s} \cdot {δ}_{s}} ( 1 - 0 . {5}_{{V}_{s}} ) \cdot p ,$$
wherein Dₛ is radial displacement of the inner cylinder body at the connecting joint, and Dₜ is radial displacement of the end plate at Rₜ; ρₜ=Rₜ/Rₒ; Eₚ is an elastic modulus of the end plate material, in MPa; δₚ is the initial wall thickness of the end plate; vₚ is a Poisson's ratio of the end plate material; kₛ is a coefficient of the inner cylinder body shell; Rₘₛ is a middle plane radius of the inner cylinder body shell, in mm, and Rₘₛ=Rₜ+0.5δs; δₛ is the initial wall thickness of the inner cylinder body; Eₛ is an elastic modulus of the inner cylinder body material, in MPa; and p is an internal pressure;
when i=2 and Dₛ=D_{d}, the following formula is obtained:
$$- \frac{2 {k}_{d} \cdot {R}_{md}^{2}}{{E}_{d} \cdot {δ}_{d}} {Q}_{1} + ( \frac{2 {k}_{s} \cdot {R}_{ms}^{2}}{Es \cdot δ s} + \frac{2 {k}_{d} \cdot {R}_{md}^{2}}{{E}_{d} \cdot {δ}_{d}} ) {Q}_{3} + \frac{2 {k}_{d}^{2} \cdot {R}_{md}^{2}}{{E}_{d} \cdot {δ}_{d}} {M}_{1} + ( \frac{2 {k}_{s}^{2} \cdot {R}_{ms}^{2}}{Es \cdot δ s} - \frac{2 {k}_{d}^{2} \cdot {R}_{md}^{2}}{{E}_{d} \cdot {δ}_{d}} ) {M}_{3} = - \frac{{R}_{ms}^{2}}{Es \cdot δ s} ( 1 - 0 . {5}_{{v}_{s}} ) \cdot p ,$$
wherein D_{d} is radial displacement of the internal distributor cylinder body at the connecting joint; E_{d} is an elastic modulus of the internal distributor cylinder body material, in MPa; R_{md} is a middle plane radius of an internal distributor cylinder body shell, in mm, and R_{md}=Rᵢ+0.5δ_{d}; δ_{d} is the initial wall thickness of the internal distributor cylinder body; and k_{d} is a coefficient of the internal distributor cylinder body shell;
when i=3 and Dₒ=D_{g}, the following formula is obtained:
$$- \frac{2 \cdot {R}_{o} \cdot {ρ}_{t}^{2}}{{E}_{p} \cdot {δ}_{p} \cdot ( 1 - {ρ}_{t}^{2} )} {Q}_{1} - ( \frac{{R}_{o}}{{E}_{p} \cdot {δ}_{p}} ( \frac{1 + {ρ}_{t}^{2}}{1 - {ρ}_{t}^{2}} - {ν}_{p} ) + \frac{2 {k}_{g} \cdot {R}_{m g}^{2}}{{E}_{g} \cdot {δ}_{g}} ) {Q}_{2} - \frac{2 {k}_{g}^{2} \cdot {R}_{m g}^{2}}{{E}_{g} \cdot {δ}_{g}} {M}_{2} = \frac{{R}_{m g}^{2}}{{E}_{g} \cdot {δ}_{g}} ( 1 - 0.5 {ν}_{g} ) \cdot p ,$$
wherein Dₒ is radial displacement of the end plate at Rₒ; D_{g} is radial displacement of the outer cylinder body at the connecting joint; E_{g} is an elastic modulus of the outer cylinder body material, in MPa; R_{mg} is a middle plane radius of an outer cylinder body shell, in mm, and R_{mg}=Rₒ+0.5δ_{g}; δ_{g} is the initial wall thickness of the outer cylinder body; and v_{g} is g a Poisson's ratio of the outer cylinder body material;
when i=4 and βₛ=βₜ, the following formula is obtained:
$$\frac{2 {k}_{s}^{2} \cdot {R}_{ms}^{2}}{{E}_{s} \cdot {δ}_{s}} {Q}_{3} + \frac{{R}_{o} \cdot {ρ}_{t}}{{D}_{p} \cdot {K}_{t t}} {M}_{1} - \frac{{R}_{o}}{{D}_{p} \cdot {K}_{tR}} {M}_{2} + \frac{4 {k}_{s}^{3} \cdot {R}_{ms}^{2}}{{E}_{s} \cdot {δ}_{s}} {M}_{3} + \frac{{R}_{o}^{2} \cdot {ρ}_{t}}{{D}_{p} \cdot {K}_{tV}} {V}_{t} = - \frac{{R}_{o}^{3}}{{D}_{p} \cdot {K}_{tp}} p ,$$
wherein βₛ is a rotation angle of the inner cylinder body at the connecting joint, βₜ is a rotation angle of the end plate at Rₜ, and K_{tR}, Kₜₜ, K_{tV}, Kₜₚ and Dₚ are all end plate calculation coefficients, and are related to geometric dimensions of the end plate;
when i=5 and βₛ=β_{d}, the following formula is obtained:
$$\frac{2 {k}_{d}^{2} \cdot {R}_{m d}^{2}}{{E}_{d} \cdot {δ}_{d}} {Q}_{1} + ( \frac{2 {k}_{s}^{2} \cdot {R}_{ms}^{2}}{{E}_{s} \cdot {δ}_{s}} - \frac{2 {k}_{d}^{2} \cdot {R}_{md}^{2}}{{E}_{d} \cdot {δ}_{d}} ) {Q}_{3} - \frac{4 {k}_{d}^{3} \cdot {R}_{md}^{2}}{{E}_{d} \cdot {δ}_{d}} {M}_{1} + ( \frac{4 {k}_{s}^{3} \cdot {R}_{ms}^{2}}{{E}_{s} \cdot {δ}_{s}} + \frac{4 {k}_{d}^{3} \cdot {R}_{md}^{2}}{{E}_{d} \cdot {δ}_{d}} ) {M}_{3} = 0 ,$$
wherein β_{d} is a rotation angle of the internal distributor cylinder body at the connecting joint;
when i=6 and βₒ=β_{g}, the following formula is obtained:
$$- \frac{2 {k}_{g}^{2} \cdot {R}_{mg}^{2}}{{E}_{g} \cdot {δ}_{g}} {Q}_{2} + \frac{{R}_{o} \cdot {ρ}_{t}}{{D}_{p} \cdot {K}_{Rt}} {M}_{1} - ( \frac{{R}_{o}}{{D}_{p} \cdot {K}_{RR}} + \frac{4 {k}_{g}^{3} \cdot {R}_{mg}^{2}}{{E}_{g} \cdot {δ}_{g}} ) {M}_{2} + \frac{{R}_{o}^{2} \cdot {ρ}_{t}}{{D}_{p} \cdot {K}_{RV}} {V}_{t} = - \frac{{R}_{o}^{3}}{{D}_{p} \cdot {K}_{Rp}} p ,$$
wherein βₒ is a rotation angle of the end plate at Rₒ, and K_{RR}, K_{Rt}, K_{RV} and K_{Rp} are all end plate calculation coefficients, and are related to geometric dimensions of the end plate; and β_{g} is a rotation angle of the outer cylinder body at the connecting joint; and
when i=7 and W_{d}=W_{g}+ΔWₚ, the following formula is obtained:
$$\frac{{R}_{o}^{2}}{{D}_{p}} \frac{{ρ}_{t}}{{K}_{VT}} \cdot {M}_{1} - \frac{{R}_{o}^{2}}{{D}_{p}} \cdot \frac{1}{{K}_{VR}} \cdot {M}_{2} + ( \frac{{L}_{g} \cdot {ρ}_{t}}{2 \cdot {E}_{g} \cdot {δ}_{g}} + \frac{{ρ}_{t} \cdot {R}_{o}^{3}}{{D}_{p} \cdot {K}_{VV}} + \frac{{L}_{g} + ( \frac{1}{ϕ} - 1 ) {L}_{belt}}{2 \cdot {E}_{d} \cdot {δ}_{d}} ) \cdot {V}_{t} = \frac{F}{2 \cdot {E}_{d} \cdot {δ}_{d}} \cdot [ {L}_{g} + ( \frac{1}{ϕ} - 1 ) {L}_{belt} ] - \frac{{L}_{g} \cdot p}{2 \cdot {E}_{g} \cdot {δ}_{g}} \cdot ( 0.5 \cdot {R}_{o} ( 1 - {ρ}_{t}^{2} ) - {R}_{mg} \cdot {v}_{g} ) - \frac{{R}_{o}^{4} \cdot p}{{D}_{p} \cdot {K}_{Vp}} ,$$
wherein W_{d} is axial displacement of an end portion of the internal distributor cylinder body, in mm; Wg is axial displacement of an end portion of the outer cylinder body, in mm; and ΔWₚ is an axial displacement difference at an inner/outer radius of the end plate, in mm.

18. The correction method for a heat exchanger system according to claim 15, wherein the calculating a stress at each position of each element in the straight-section external guide cylinder based on a solution of the seven-order matrix equations specifically comprises:
solving the seven-order matrix equations;
determining a bending moment and a force of each element in the straight-section external guide cylinder at a connecting joint based on the solution of the seven-order matrix equations, wherein the solution of the seven-order matrix equations comprises the bending moment per unit circumference and the radial force per unit circumference at the connecting joint between the outer cylinder body and the end plate, the bending moment per unit circumference and the radial force per unit circumference at the connecting joint between the end plate and the outer cylinder body, the bending moment per unit circumference and the radial force per unit circumference at the connecting joint between the inner cylinder body and the end plate, the bending moment per unit circumference and the radial force per unit circumference at the connecting joint between the end plate and the inner cylinder body, the bending moment per unit circumference and the radial force per unit circumference at the connecting joint between the internal distributor cylinder body and the end plate, and the unit shear force at the end plate Rt, and the unit shear force acting on the end plate at Rₜ; and
calculating the stress of each element in the straight-section external guide cylinder at each position based on the bending moment and the force of the element in the straight-section external guide cylinder at the connecting joint.

19. The correction method for a heat exchanger system according to claim 15, wherein the correcting the heat exchanger system based on the axial stiffness of the straight-section external guide cylinder specifically comprises:
correcting and calculating total stiffness of the shell-side cylinder body of a heat exchanger based on the axial stiffness of the straight-section external guide cylinder and stiffness of shell-side residual cylinder body of the heat exchanger;
calculating a thickness of an equivalent cylinder body based on corrected total stiffness of the shell-side cylinder body of the heat exchanger; and
correcting the heat exchanger system based on the thickness of the equivalent cylinder body.

20. The correction method for a heat exchanger system according to claim 16, wherein the correcting the heat exchanger system based on the axial stiffness of the straight-section external guide cylinder specifically comprises:
correcting and calculating total stiffness of the shell-side cylinder body of a heat exchanger based on the axial stiffness of the straight-section external guide cylinder and stiffness of shell-side residual cylinder body of the heat exchanger;
calculating a thickness of an equivalent cylinder body based on corrected total stiffness of the shell-side cylinder body of the heat exchanger; and
correcting the heat exchanger system based on the thickness of the equivalent cylinder body.

21. The correction method for a heat exchanger system according to claim 17, wherein the correcting the heat exchanger system based on the axial stiffness of the straight-section external guide cylinder specifically comprises:
correcting and calculating total stiffness of the shell-side cylinder body of a heat exchanger based on the axial stiffness of the straight-section external guide cylinder and stiffness of shell-side residual cylinder body of the heat exchanger;
calculating a thickness of an equivalent cylinder body based on corrected total stiffness of the shell-side cylinder body of the heat exchanger; and
correcting the heat exchanger system based on the thickness of the equivalent cylinder body.

22. The correction method for a heat exchanger system according to claim 18, wherein the correcting the heat exchanger system based on the axial stiffness of the straight-section external guide cylinder specifically comprises:
correcting and calculating total stiffness of the shell-side cylinder body of a heat exchanger based on the axial stiffness of the straight-section external guide cylinder and stiffness of shell-side residual cylinder body of the heat exchanger;
calculating a thickness of an equivalent cylinder body based on corrected total stiffness of the shell-side cylinder body of the heat exchanger; and
correcting the heat exchanger system based on the thickness of the equivalent cylinder body.

23. A safety evaluation system for a straight-section external guide cylinder, wherein the straight-section external guide cylinder is provided with an internal distributor, and comprises four elements, namely, an inner cylinder body, an outer cylinder body, an end plate, and an internal distributor cylinder body, and the safety evaluation system for a straight-section external guide cylinder comprises:
a ½ symmetrical mechanical model building module, configured to establish a ½ symmetrical mechanical model based on symmetrical structural characteristics and real load conditions of the straight-section external guide cylinder, wherein the ½ symmetrical mechanical model comprises an initial wall thickness of the inner cylinder body with an inner diameter of Rᵢ, an initial wall thickness of the outer cylinder body with an inner diameter of Rₒ, an initial wall thickness of the end plate connecting the inner cylinder body to the outer cylinder body, and an initial wall thickness of the internal distributor cylinder body with an inner diameter of Rᵢ; and the real load conditions comprise a medium internal pressure load and a set axial force load of the straight-section external guide cylinder;
a formula construction module, configured to construct a radial displacement formula and a rotation angle formula for each element in the straight-section external guide cylinder based on the ½ symmetrical mechanical model, wherein the radial displacement formula for each element in the straight-section external guide cylinder comprises a radial displacement formula of the inner cylinder body at a connecting joint, a radial displacement formula of the outer cylinder body at a connecting joint, a radial displacement formula of the end plate at Rₜ, a radial displacement formula of the end plate at Rₒ, and a radial displacement formula of the internal distributor cylinder body at a connecting joint; and the rotation angle formula for each element in the straight-section external guide cylinder comprises a rotation angle formula of the inner cylinder body at the connecting joint, a rotation angle formula of the outer cylinder body at the connecting joint, a rotation angle formula of the end plate at Rₜ, a rotation angle formula of the end plate at Rₒ, and a rotation angle formula of the internal distributor cylinder body at the connecting joint;
a matrix equation establishing module, configured to construct seven-order matrix equations based on the radial displacement formula and the rotation angle formula for each element in the straight-section external guide cylinder, wherein the seven-order matrix equations represent a deformation coordination relationship and an interaction force relationship among the inner cylinder body, the outer cylinder body, the end plate and the internal distributor cylinder body in the straight-section external guide cylinder;
a stress calculation module, configured to calculate a stress at each position of each element in the straight-section external guide cylinder based on a solution of the seven-order matrix equations, wherein the stress comprises a bending stress and a membrane stress of the outer cylinder body, a bending stress and a membrane stress of the end plate, a bending stress and a membrane stress of the inner cylinder body, and a bending stress and a membrane stress of the internal distributor cylinder body; the bending stress of each cylinder body comprises a circumferential bending stress and a meridional bending stress; the membrane stress of the cylinder body comprises a circumferential membrane stress and a meridional membrane stress; the cylinder body comprises the outer cylinder body, the inner cylinder body, and the internal distributor cylinder body; the bending stress of the end plate comprises a circumferential bending stress and a radial bending stress; the membrane stress of the end plate comprises a circumferential membrane stress and a radial membrane stress; and
a final wall thickness calculation module, configured to determine a maximum stress of each element in the straight-section external guide cylinder based on the stress at each position of each element in the straight-section external guide cylinder, and perform strength evaluation on the element in the straight-section external guide cylinder based on the maximum stress of each element in the straight-section external guide cylinder, to determine a final wall thickness of each element, wherein the maximum stress comprises a maximum bending stress and a maximum membrane stress.

24. The safety evaluation system for a straight-section external guide cylinder according to claim 23, wherein the seven-order matrix equations are:
$${{\sum }^{7}}_{j = 1} {F}_{ij} {x}_{j} = {F}_{ip}$$
$$i = 1 , 2 , … 7$$
$$\{ {x}_{j} \} = \{ {Q}_{1} , {Q}_{2} , {Q}_{3} , {M}_{1} , {M}_{2} , {M}_{3} , {V}_{t} \} ,$$
wherein Q₁=Qₜ; Q₂=Q_{g}=−Qₒ; Q₃=Qₛ; Q_{d}=Qₜ−Qₛ=Qₜ−Q₃; M₁=Mₜ; M₂=Mₒ=M_{g}; M₃=Mₛ; M_{d}=Mₛ−Mₜ=M₃−M₁; Qₜ is a radial force per unit circumference at a connecting joint Rₜ between the end plate and the inner cylinder body, Q_{g} is a radial force per unit circumference at a connecting joint between the outer cylinder body and the end plate, Qₒ is a radial force per unit circumference at a connecting joint Rₒ between the end plate and the outer cylinder body, Qₛ is a radial force per unit circumference at a connecting joint between the inner cylinder body and the end plate, and Q_{d} is a radial force per unit circumference at a connecting joint between the internal distributor cylinder body and the end plate; Mₜ is a bending moment per unit circumference at the connecting joint Rₜ between the end plate and the inner cylinder body, Mₒ is a bending moment per unit circumference at the connecting joint Rₒ between the end plate and the outer cylinder body, M_{g} is a bending moment per unit circumference at the connecting joint between the outer cylinder body and the end plate, Mₛ is a bending moment per unit circumference at the connecting joint between the inner cylinder body and the end plate, and M_{d} is a bending moment per unit circumference at the connecting joint between the internal distributor cylinder body and the end plate; and Vₜ is a unit shear force acting on the end plate at Rₜ;
when i=1 and Dₛ=Dₜ the following formula is obtained:
$$( \frac{{ρ}_{t} \cdot {R}_{o}}{{E}_{p} \cdot {δ}_{p}} ( \frac{1 + {ρ}_{t}^{2}}{1 - {ρ}_{t}^{2}} + {v}_{p} ) {Q}_{1} + \frac{2 \cdot {ρ}_{t} \cdot {R}_{o}}{{E}_{p} \cdot {δ}_{p} \cdot ( 1 - {ρ}_{t}^{2} )} {Q}_{2} + \frac{2 {k}_{s} \cdot {R}_{ms}^{2}}{{E}_{s} \cdot {δ}_{s}} {Q}_{3} + \frac{2 {k}_{s}^{2} \cdot {R}_{ms}^{2}}{{E}_{s} \cdot {δ}_{s}} {M}_{3} = - \frac{{R}_{ms}^{2}}{{E}_{s} \cdot {δ}_{s}} ( 1 - 0 . {5}_{{V}_{s}} ) \cdot p ,$$
wherein Dₛ is radial displacement of the inner cylinder body at the connecting joint, and Dₜ is radial displacement of the end plate at Rₜ; ρₜ=Rₜ/Rₒ; Eₚ is an elastic modulus of the end plate material, in MPa; δₚ is the initial wall thickness of the end plate; vₚ is a Poisson's ratio of the end plate material; kₛ is a coefficient of the inner cylinder body shell; Rₘₛ is a middle plane radius of the inner cylinder body shell, in mm, and Rₘₛ=Rᵢ+0.5δₛ; δₛ is the initial wall thickness of the inner cylinder body; Eₛ is s an elastic modulus of the inner cylinder body material, in MPa; and p is an internal pressure;
when i=2 and Dₛ=D_{d}, the following formula is obtained:
$$- \frac{2 {k}_{d} \cdot {R}_{md}^{2}}{{E}_{d} \cdot {δ}_{d}} {Q}_{1} + ( \frac{2 {k}_{s} \cdot {R}_{ms}^{2}}{Es \cdot δ s} + \frac{2 {k}_{d} \cdot {R}_{md}^{2}}{{E}_{d} \cdot {δ}_{d}} ) {Q}_{3} + \frac{2 {k}_{d}^{2} \cdot {R}_{md}^{2}}{{E}_{d} \cdot {δ}_{d}} {M}_{1} + ( \frac{2 {k}_{s}^{2} \cdot {R}_{ms}^{2}}{Es \cdot δ s} - \frac{2 {k}_{d}^{2} \cdot {R}_{md}^{2}}{{E}_{d} \cdot {δ}_{d}} ) {M}_{3} = - \frac{{R}_{ms}^{2}}{Es \cdot δ s} ( 1 - 0.5 {v}_{s} ) \cdot p ,$$
wherein D_{d} is radial displacement of the internal distributor cylinder body at the connecting joint; E_{d} is an elastic modulus of the internal distributor cylinder body material, in MPa; R_{md} is a middle plane radius of an internal distributor cylinder body shell, in mm, and R_{md}=Rᵢ+0.5δ_{d}; δ_{d} is the initial wall thickness of the internal distributor cylinder body; and k_{d} is a coefficient of the internal distributor cylinder body shell;
when i=3 and Dₒ=D_{g}, the following formula is obtained:
$$- \frac{2 \cdot {R}_{o} \cdot {ρ}_{t}^{2}}{{E}_{p} \cdot {δ}_{p} \cdot ( 1 - {ρ}_{t}^{2} )} {Q}_{1} - ( \frac{{R}_{o}}{{E}_{p} \cdot {δ}_{p}} ( \frac{1 + {ρ}_{t}^{2}}{1 - {ρ}_{t}^{2}} - {v}_{p} ) + \frac{2 {k}_{g} \cdot {R}_{mg}^{2}}{{E}_{g} \cdot {δ}_{g}} ) {Q}_{2} - \frac{2 {k}_{g}^{2} \cdot {R}_{mg}^{2}}{{E}_{g} \cdot {δ}_{g}} {M}_{2} = \frac{{R}_{mg}^{2}}{{E}_{g} \cdot {δ}_{g}} ( 1 - 0.5 {v}_{g} ) \cdot p ,$$
wherein Dₒ is radial displacement of the end plate at Rₒ; D_{g} is radial displacement of the outer cylinder body at the connecting joint; E_{g} is an elastic modulus of the outer cylinder body material, in MPa; R_{mg} is a middle plane radius of an outer cylinder body shell, in mm, and R_{mg}=Rₒ+0.5δ_{g}; δ_{g} is the initial wall thickness of the outer cylinder body; and v_{g} is a Poisson's ratio of the outer cylinder body material;
when i=4 and βₛ=βₜ, the following formula is obtained:
$$\frac{2 {k}_{s}^{2} \cdot {R}_{ms}^{2}}{{E}_{s} \cdot {δ}_{s}} {Q}_{3} + \frac{{R}_{o} \cdot {ρ}_{t}}{{D}_{p} \cdot {K}_{tt}} {M}_{1} - \frac{{R}_{o}}{{D}_{p} \cdot {K}_{tR}} {M}_{2} + \frac{4 {k}_{s}^{3} \cdot {R}_{ms}^{2}}{{E}_{s} \cdot {δ}_{s}} {M}_{3} + \frac{{R}_{o}^{2} \cdot {ρ}_{t}}{{D}_{p} \cdot {K}_{tV}} {V}_{t} = - \frac{{R}_{o}^{3}}{{D}_{p} \cdot {K}_{tp}} p ,$$
wherein βₛ is a rotation angle of the inner cylinder body at the connecting joint, βₜ is a rotation angle of the end plate at Rₜ, and K_{tR}, Kₜₜ, K_{tV}, K_{tP} and Dₚ are all end plate calculation coefficients, and are related to geometric dimensions of the end plate;
when i=5 and βₛ=−β_{d}, the following formula is obtained:
$$\frac{2 {k}_{d}^{2} \cdot {R}_{md}^{2}}{{E}_{d} \cdot {δ}_{d}} {Q}_{1} + ( \frac{2 {k}_{s}^{2} \cdot {R}_{ms}^{2}}{{E}_{s} \cdot {δ}_{s}} - \frac{2 {k}_{d}^{2} \cdot {R}_{md}^{2}}{{E}_{d} \cdot {δ}_{d}} ) {Q}_{3} - \frac{4 {k}_{d}^{3} \cdot {R}_{md}^{2}}{{E}_{d} \cdot {δ}_{d}} {M}_{1} + ( \frac{4 {k}_{s}^{3} \cdot {R}_{ms}^{2}}{{E}_{s} \cdot {δ}_{s}} + \frac{4 {k}_{d}^{3} \cdot {R}_{md}^{2}}{{E}_{d} \cdot {δ}_{d}} ) {M}_{3} = 0 ,$$
wherein β_{d} is a rotation angle of the internal distributor cylinder body at the connecting joint;
when i=6 and βₒ=β_{g}, the following formula is obtained:
$$- \frac{2 {k}_{g}^{2} \cdot {R}_{mg}^{2}}{{E}_{g} \cdot {δ}_{g}} {Q}_{2} + \frac{{R}_{o} \cdot {ρ}_{t}}{{D}_{p} \cdot {K}_{Rt}} {M}_{1} - ( \frac{{R}_{o}}{{D}_{p} \cdot {K}_{RR}} + \frac{4 {k}_{g}^{3} \cdot {R}_{mg}^{2}}{{E}_{g} \cdot {δ}_{g}} ) {M}_{2} + \frac{{R}_{o}^{2} \cdot {ρ}_{t}}{{D}_{p} \cdot {K}_{R V}} {V}_{t} = - \frac{{R}_{o}^{3}}{{D}_{p} \cdot {K}_{Rp}} p ,$$
wherein βₒ is a rotation angle of the end plate at Rₒ, and K_{RR}, K_{Rt}, K_{RV} and K_{Rp} are all end plate calculation coefficients, and are related to geometric dimensions of the end plate; and β_{g} is a rotation angle of the outer cylinder body at the connecting joint; and
when i=7 and W_{d}=W_{g}+ΔWₚ, the following formula is obtained:
$$\frac{{R}_{o}^{2}}{{D}_{p}} \frac{{ρ}_{t}}{{K}_{V Γ}} \cdot {M}_{1} - \frac{{R}_{o}^{2}}{{D}_{p}} \cdot \frac{1}{{K}_{VR}} \cdot {M}_{2} + ( \frac{{L}_{g} \cdot {ρ}_{t}}{2 \cdot {E}_{g} \cdot {δ}_{g}} + \frac{{ρ}_{t} \cdot {R}_{o}^{3}}{{D}_{p} \cdot {K}_{VV}} + \frac{{L}_{g} + ( \frac{1}{ϕ} - 1 ) {L}_{belt}}{2 \cdot {E}_{d} \cdot {δ}_{d}} ) \cdot {V}_{t} = \frac{F}{2 \cdot {E}_{d} \cdot {δ}_{d}} \cdot [ {L}_{g} + ( \frac{1}{ϕ} - 1 ) {L}_{belt} ] - \frac{{L}_{g} \cdot p}{2 \cdot {E}_{g} \cdot {δ}_{g}} \cdot ( 0.5 \cdot {R}_{o} ( 1 - {ρ}_{t}^{2} ) - {R}_{mg} \cdot {v}_{g} ) - \frac{{R}_{o}^{4} \cdot p}{{D}_{p} \cdot {K}_{Vp}} ,$$
wherein W_{d} is axial displacement of an end portion of the internal distributor cylinder body, in mm; Wg is axial displacement of an end portion of the outer cylinder body, in mm; and ΔWp is an axial displacement difference at an inner/outer radius of the end plate, in mm.
